(19) United States
(12) Patent Application Publication
(10) Pub. No.: US 2023/0021871 A1
(43) Pub. Date: Jan. 26, 2023

(54) PLANAR BIDIRECTIONAL OPTICAL COUPLER FOR WAVELENGTH DIVISION MULTIPLEXING

(71) Applicant: ULTRA COMMUNICATIONS, INC., Vista, CA (US)

(72) Inventors: Charles B. KUZNIA, ENCINITAS, CA (US); Joseph Farzin AHADIAN, SAN MARCOS, CA (US); Sandra SKENDZIC, VISTA, CA (US); Vernon Eugene SHRAUGER, CAMBRIDGE, MA (US)

(21) Appl. No.: 17/812,967

(22) Filed: Jul. 15, 2022

Related U.S. Application Data
(60) Provisional application No. 63/268,584, filed on Feb. 25, 2022.
(60) Provisional application No. 63/224,696, filed on Jul. 22, 2021.

(51) Int. Cl. G02B 6/42; H04B 10/071

(52) U.S. Cl. CPC G02B 6/4246; H04B 10/071; H04J 14/02

(57) ABSTRACT

Methods and devices for a planar bidirectional optical coupler for wavelength division multiplexing are described. The optical coupler can be used in an optical transceiver housed within a compact optical interconnect module for optical fiber-based data communication and/or OTDR measurement. According to one aspect, the optical coupler includes a layered planar construction, each layer based on a transparent planar substrate. A bottom carrier layer includes a metallized surface for mounting of electronic and/or electro-optical components. A lens layer overlays the carrier layer and includes collimating transmit and/or focusing receive lenses. A beam splitter/combiner layer overlays the lens layer and includes angled coated lateral surfaces that provide beam splitting and wavelength filtering functionality. The beam splitter/combiner layer is optically coupled to a ferrule receptacle of a fiber connector of the optical transceiver. Alternatively, the beam splitter/combiner is optically coupled to a planar optical fiber connector via an additional lens guide layer.

### CROSS REFERENCE TO RELATED APPLICATIONS

The present application is a U.S. non-provisional application claiming priority to U.S. provisional application No. 63/268,584 filed on Feb. 25, 2022, and U.S. provisional application No. 63/224,696 filed on Jul. 22, 2021, the contents of all of which are incorporated herein by reference in their entirety.

### GOVERNMENT SUPPORT

This invention was made with government support under grant N68335-17-C-0197 awarded by the US Navy. The US government has certain rights in the invention.

### TECHNICAL FIELD

The present disclosure relates to wavelength division multiplexing (WDM) devices and methods for applying same. Embodiments in accordance with the present disclosure may be applied to couple multiple light sources and/or light detectors to an optical fiber for multichannel bidirectional optical data communication and/or optical time domain reflectometer (OTDR) functionality integrated in a compact and low-cost planar package.

### BACKGROUND

Fiber optics (a term synonymous with optical fibers) offers high data rate and electromagnetic interference immunity for high-speed data communications. While being utilized for long distance links, fiber optics is now becoming prevalent in applications with short distance, for example within data centers, aircraft systems, and ship-board systems. These systems would benefit from incorporation of an optical time domain reflectometer (OTDR) with high resolution to determine the precise location of fiber faults, breaks, discontinuities, or configuration changes.

Optical transceivers are widely used in high-speed data transmission and reception using fiber optics as part of an optical data communication system. An optical transceiver supports bidirectional optical communication, that is it can both transmit and receive optical signals. A relatively new technology, short wavelength division multiplexing (SWDM), allows boost in transmission (and therefore reception) capacity by simultaneously transmitting optical signals in four different wavelengths over a single multimode optical fiber (MMF). A typical implementation of an optical transceiver for use in a SWDM optical interconnect module includes four separate channels centered at respective wavelengths of 850 nm, 880 nm, 910 nm and 940 nm, each channel being enabled by a low-cost vertical-cavity surface emitting laser (VCSEL). The optical transceiver typically has a transmit side with four VCSELs generating optical signals, one VCSEL for each channel, and a receive side with four light detectors, each detecting optical signals being transmitted in one of the four channels. Often one optical fiber carries the transmit optical signals and a separate optical fiber carries the receive optical channels. In some cases, the transmit and receive signals may be combined and propagate through a signal optical fiber.

To support bidirectional operation, an optical transceiver with wavelength division multiplexing capability may include a bidirectional optical coupler that couples, for each of the four multiplexed channels, light from a light emitter to a (multimode) fiber for transmission of a corresponding transmit signal through the fiber, and couples light from either the same fiber or from a different fiber to a light detector for detection of a corresponding receive signal through the fiber. The bidirectional optical coupler should be compact enough to fit within a size constraint of the optical transceiver, while providing, for each of the four multiplexed channels, an optical performance that is sufficient for transmission and reception of high-speed optical signals over long distances/links. If desired, optical time domain reflectometer (OTDR) functionality may also be provided within a same housing used for the optical transceiver.

As mass production and commercial success of an optical transceiver with wavelength division multiplexing capability, such as SWDM multiplexing, may be heavily impacted by cost and ease of manufacturing of the transceiver, it follows that streamlining manufacturing of the bidirectional optical coupler to a scalable technology that allows use of simple and established assembly techniques while simplifying integration within the optical transceiver may be desirable. This is the subject of the teachings according to the present disclosure.

### SUMMARY

The disclosed methods and devices allow streamlining manufacturing of a bidirectional optical coupler that may be used in an optical transceiver with wavelength division multiplexing capability, including short wavelength division multiplexing (SWDM), by using optical components that are fabricated with planar technology that can scale (i.e., wafer scale) for high production runs and therefore reduced cost. Such planar technology allows use of established planar assembly techniques of optical, electro-optical and electronic components of the transceiver, such as for example, flip-chip bonding. Furthermore, transparent planar substrates used in the fabrication of the (bidirectional) optical coupler (i.e., optical subassembly) may facilitate alignment of optical components of the optical coupler to counterpart electro-optical components of the transceiver that may be arranged on different (planar) layers/substrates. Accordingly, the optical coupler of the present teachings can reduce complexity and cost of manufacturing and assembly of an optical transceiver with wavelength division multiplexing capability that may be used for data communication (e.g., SWDM) and/or OTDR measurement in a compact fiber optic transceiver packaging format.

The following presents a simplified summary in order to provide a basic understanding of some aspects of the claimed subject matter. This summary is not an extensive overview and is not intended to identify key/critical elements or to delineate the scope of the claimed subject matter. Its purpose is to present some concepts in a simplified form as a prelude to the more detailed description that is presented later.

According to an aspect of the present disclosure, a wavelength division multiplexing (WDM) optical interconnect module for optical data communication based on a plurality of wavelengths is presented, such optical interconnect module comprising: a planar bidirectional optical coupler, comprising: a transparent carrier substrate comprising a metallized surface; a transparent lens substrate comprising a plurality of collimating lenses and focusing lenses, the transparent lens substrate overlying the transparent carrier substrate; and a beam splitter/combiner assembly comprising a plurality of coated lateral surfaces, the beam splitter/combiner assembly overlying the transparent lens substrate, wherein each coated lateral surface of the plurality of coated lateral surfaces is configured to reflect light of a respective wavelength of the plurality of wavelengths and pass light of a wavelength different from the respective wavelength.

According to a further aspect of the present disclosure, a wavelength division multiplexing (WDM) optical interconnect module for optical data communication based on a plurality of wavelengths is presented, such optical interconnect module comprising: a planar bidirectional optical coupler, comprising: a transparent carrier substrate comprising: a metallized surface comprising a plurality of electro-optical elements; a transparent lens substrate comprising a plurality of collimating lenses and focusing lenses, the transparent lens substrate overlying the transparent carrier substrate; and a beam splitter/combiner assembly comprising a plurality of coated lateral surfaces, the beam splitter/combiner assembly overlying the transparent lens substrate, wherein each coated lateral surface of the plurality of coated lateral surfaces is configured to reflect light of a respective wavelength of the plurality of wavelengths and pass light of a wavelength different from the respective wavelength.

According to a yet further aspect of the present disclosure, another embodiment of a wavelength division multiplexing optical interconnect module is described. The wavelength division multiplexing optical interconnect module includes a planar bidirectional optical coupler. The planar bidirectional optical coupler is comprised of a transparent carrier substrate, a transparent lens substrate, and a beam splitter/combiner layer. The beam splitter/combiner layer overlays the transparent lens substrate, which in turn overlays the transparent carrier substrate. The transparent carrier substrate has a bottom surface with a light emitter assembly mounted on it and an opposed top surface. The light emitter assembly is configured to emit light from a plurality of emitting apertures, each emitting aperture configured to emit light at a different wavelength. The transparent lens substrate is comprised of a plurality of collimating lenses and a focusing lens. The beam splitter/combiner layer is comprised of a first beam splitter/combiner assembly having a plurality of coated lateral surfaces. A first coated lateral surface of the plurality of coated lateral surfaces is optically aligned with the focusing lens and the light detector and of the each of the plurality of coated lateral surfaces are optically aligned with a collimating lens of the plurality of collimating lenses and each of the plurality of coated lateral surfaces reflects light at a wavelength emitted by the light emitter assembly.

According to a yet further aspect of the present disclosure another embodiment of a wavelength division multiplexing optical interconnect module is described. The wavelength division multiplexing optical interconnect module includes a planar unidirectional optical coupler. The planar unidirectional optical coupler is comprised of a transparent carrier substrate, a transparent lens substrate, and a beam combiner layer. The beam combiner layer overlays the transparent lens substrate, which in turn overlays the transparent carrier substrate. The transparent carrier substrate has a bottom surface with a light emitter assembly mounted on it and an opposed top surface. The light emitter assembly is configured to emit light from a plurality of emitting apertures, each emitting aperture configured to emit light at a different wavelength. The transparent lens substrate is comprised of a plurality of collimating lenses. The beam combiner layer is comprised of a beam combiner assembly having a plurality of coated lateral surfaces. Each coated lateral surface of the plurality of coated lateral surfaces and each collimating lens of the plurality of collimating lenses are optically aligned with each emitting aperture of the light emitter assembly and each coated lateral surface reflects light at a wavelength emitted by the light emitter assembly.

According to a yet further aspect of the present disclosure another embodiment of a wavelength division multiplexing optical interconnect module is described. The wavelength division multiplexing optical interconnect module includes a planar unidirectional optical coupler. The planar unidirectional optical coupler is comprised of a transparent carrier substrate, a transparent lens substrate, and a beam splitter layer. The beam splitter layer overlays the transparent lens substrate, which in turn overlays the transparent carrier substrate. The transparent carrier substrate has a bottom surface with a light detector assembly mounted on it and an opposed top surface. The light detector assembly is configured to detect light at a plurality of detecting apertures, each detecting aperture configured to detect light at a different wavelength. The transparent lens substrate is comprised of a plurality of receive focusing lenses. The beam splitter layer is comprised of a beam splitter assembly having a plurality of coated lateral surfaces. Each coated lateral surface of the plurality of coated lateral surfaces and each receive focusing lens of the plurality of receive focusing lenses are optically aligned with each detecting aperture of the light detector assembly and each coated lateral surface reflects light at a wavelength detected by the light detector assembly.

According to a yet further aspect of the present disclosure another embodiment of a wavelength division multiplexing optical interconnect module is described. The wavelength division multiplexing optical interconnect module includes a planar bidirectional optical coupler.

Further aspects of the disclosure are shown in the specification, drawings and claims of the present application.

### BRIEF DESCRIPTION OF DRAWINGS

FIG. 1A shows an exploded view of an optical transceiver with wavelength division multiplexing capability including a planar bidirectional optical coupler according to an embodiment of the present disclosure.

FIG. 1B shows an isometric view of the optical transceiver of FIG. 1A in an assembled state.

FIG. 2 shows details of the planar bidirectional optical coupler in a transmit side of the optical transceiver of FIG. 1A.

FIG. 3 shows details of the planar bidirectional optical coupler in a receive side of the optical transceiver of FIG. 1A.

FIG. 4 shows details of optical paths in the transmit side of the optical transceiver of FIG. 1A.

FIG. 5A shows details of optical paths in a transmit side of an optical transceiver comprising the planar bidirectional optical coupler, the optical transceiver coupled to an optical fiber having an optical axis contained within a plane of the planar bidirectional optical coupler.

FIG. 5B shows details of optical paths in a receive side of the optical transceiver of FIG. 5A.

FIG. 5C shows an alternative configuration of the planar bidirectional optical coupler that may be used in the optical transceiver of FIG. 5A and FIG. 5B.

FIG. 6A shows details of optical paths in a receive side of an optical transceiver comprising the planar bidirectional optical coupler of FIG. 5C, the optical transceiver coupled to an optical fiber having an optical axis that is not contained within a plane of the planar bidirectional optical coupler.

FIG. 6B shows details of an alternative configuration for providing the optical paths shown in FIG. 6A.

FIG. 6C shows an alternative configuration of a beam splitter/combiner layer used in the bidirectional optical coupler.

FIG. 6D shows a different orientation of surfaces of the beam splitter/combiner layer.

FIG. 7A shows details of optical paths in a transmit side and a receive side of an optical transceiver comprising the planar bidirectional optical coupler of FIG. 6D, the optical transceiver coupled to respective receive and transmit optical fibers having respective optical axes contained within a plane that is not contained within a plane of the planar bidirectional optical coupler.

FIG. 7B shows coupling of a planar fiber connector to the optical transceiver of FIG. 7A.

FIG. 7C shows further details of the coupling of FIG. 7A, including a plurality of receive and/or transmit optical fibers of the planar fiber connector coupled to the planar bidirectional optical coupler.

FIG. 7D shows details of an alignment pattern comprised in the bidirectional optical coupler for mounting of the planar fiber connector to the optical transceiver.

FIG. 8A shows details of an exemplary planar fiber connector coupled to the optical transceiver of FIG. 7A, with the optical transceiver mounted on a printed circuit board.

FIG. 8B and FIG. 8C show respective top and isometric view of the configuration shown in FIG. 7C.

FIG. 9 shows an isometric view of a beam splitter/combiner layer.

Like reference numbers and designations in the various drawings indicate like elements.

### DETAILED DESCRIPTION

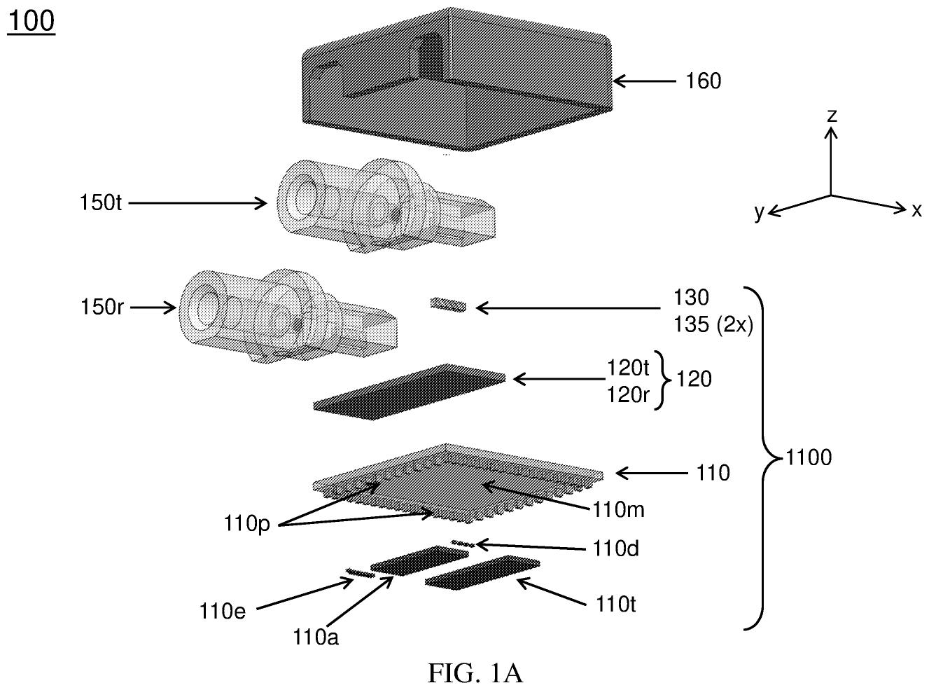

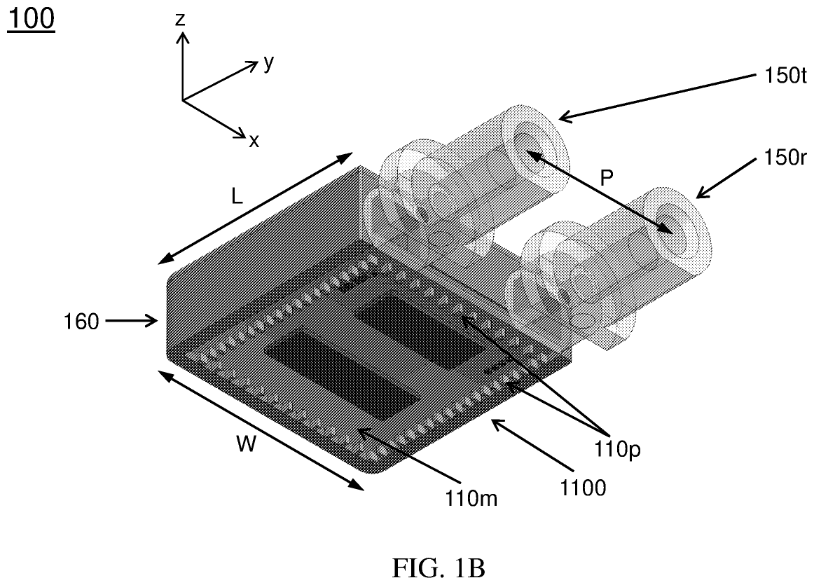

FIG. 1A shows an exploded view of a WDM optical interconnect module (100) according to an embodiment of the present disclosure that includes wavelength division multiplexing capability for use, for example, in a SWDM optical interconnect module. The WDM optical interconnect module (100) may be an optical transceiver, an optical transmitter, or an optical receiver. The WDM optical interconnect module (100) may support symmetric bidirectional operation, having equal communication bandwidths on the transmit and receive side of the WDM optical interconnect module (100) or the WDM optical interconnect module (100) may support asymmetric bidirectional operation, where the transmit side has WDM capabilities with multiple communication channels and the receive side supports only a single communication channel. In some embodiments the WDM optical interconnect module (100) may only support unidirectional operation and have only a transmit side without any receive capabilities or a receive side without any transmit capabilities. Based on the following description, it would be clear to a person skilled in the art that the present teachings are not limited to a four-channel multiplexed configuration according to the SWDM standard, rather, such teachings may enable any multichannel multiplexed configuration based on a same planar construction. In the description below the WDM optical interconnect module (100) is generally described as an optical transceiver; however, it should be recognized that for an optical transmitter the receive side may be omitted from the WDM optical interconnect module (100) and for an optical receiver the transmit side may be omitted from the WDM optical interconnect module (100).

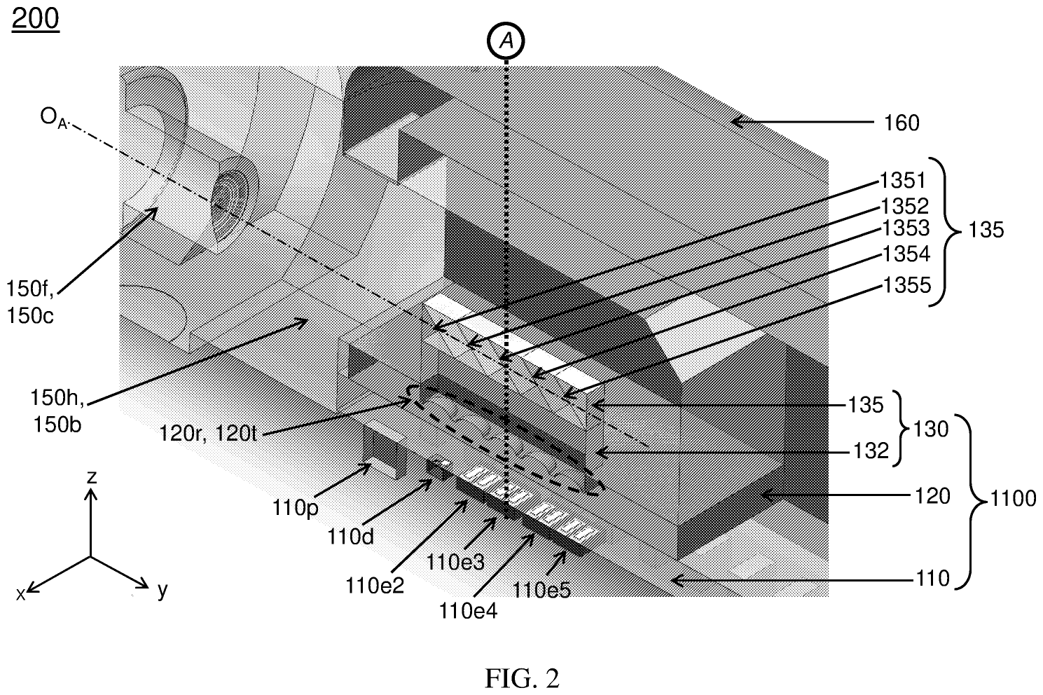

The optical transceiver (100) of FIG. 1A includes a planar bidirectional optical coupler (1100) that is coupled to transmit and receive optical fiber connectors (150t, 150r), and a lid/housing (160) for fitting/mating of the planar bidirectional optical coupler (1100) and the connectors (150t, 150r). The planar bidirectional optical coupler (1100) enables transmission of a plurality of multiplexed optical signals (e.g., modulated light) at respective wavelengths through a transmit optical fiber (not shown) coupled to the transmit optical fiber connector (150t) via a ferrule receptacle (e.g., 150f of FIG. 2 later described). The transmit optical fiber is preferably a multimode optical fiber, however, it some embodiments it may be a single mode optical fiber. Similarly, the planar bidirectional optical coupler (1100) enables reception of a plurality of multiplexed optical signals (e.g., modulated light) at respective wavelengths through a receive optical fiber (not shown) coupled to the receive optical fiber connector (150r) via a ferrule receptacle (e.g., 150f of FIG. 2 later described). The receive optical fiber is preferably a multimode optical fiber, however, it some embodiments it may be a single mode optical fiber.

With continued reference to FIG. 1A, the planar bidirectional optical coupler (1100) includes a layered planar configuration comprising a top planar layer (130) acting as a multichannel (optical) beam splitter/combiner, a middle transparent planar layer (120) acting as a lens layer, and a bottom transparent planar layer (110) acting as a carrier of electronic and/or electro-optical components. It is noted that transparency in the present context refers to transparency with respect to (all of the) wavelengths of the receive and transmit optical signals. It is further noted that the layered planar configuration is according to a plane (e.g., x, y of FIG. 1B) that is (substantially) orthogonal to the direction z according to which the different planar layers (110, 120, 130) are stacked. The bottom transparent planar layer (110) may be described as a transparent carrier substrate. The middle transparent planar layer (120) may be described as a transparent lens substrate that overlays the transparent carrier substrate. The top planar layer (130) may be described as a beam splitter assembly that overlays the transparent carrier substrate. Terms such as “bottom”, “top”, “below”, and “overlay” are relative terms based on the z-axis depicted in FIG. 1A pointing in an upward direction. The WDM optical interconnect module may be used in any orientation.

With continued reference to FIG. 1A, according to an embodiment of the present disclosure, the bottom transparent planar layer or carrier layer (110) may include a (bottom) metallized surface (110m) facing outwardly (i.e., direction −z) for provision of electrical contacts to electronic and/or electro-optical components (e.g., 110e, 110d, 110a, 110t, 110p) of the transceiver (100) and/or routing of electrical signals to/from such components from/to a main or host circuit board (not shown). According to an exemplary embodiment, dimensions in the (x, y) plane of the carrier layer (110) may be in view of a bottom opening of the lid/housing (160). For example, as shown in FIG. 1B later described, the dimensions in the (x, y) plane of the carrier layer (110) may be such as to (tightly) fit into the bottom opening of the lid/housing (160).

As shown in FIG. 1A, according to an exemplary embodiment of the present disclosure, the metallized surface (110m) of the carrier layer (110) may include a light emitter assembly (110e) that is configured to emit light at a plurality of wavelengths that are multiplexed for transmission (i.e., of a plurality of transmit optical signals) through the transmit fiber connector (150t), and a light detector assembly (110d) that is configured to receive light at a plurality of wavelengths that are multiplexed for reception (i.e., of a plurality of receive optical signals) through the receive fiber connector (150r). The light emitter assembly (110e) has a plurality of emitting apertures, which are each configured to emit an optical signal at different wavelength. The light detector assembly (110d) has a plurality of receiving apertures, which are each configured to detect an optical signal at a different wavelength. A transmit optical fiber (not shown in FIG. 1A) is configured to mate with the fiber connector (150t) and a receive optical fiber (not shown in FIG. 1A) is configured to mate with the fiber connector (150r). It is noted that the light emitter assembly (110e) may include a plurality of vertical-cavity surface emitting lasers (VCSELs) arranged in a row, each of the VCSELs emitting light at a different wavelength, such as, for example, at a wavelength for short SWDM functionality. Likewise, the light detector assembly (110d) may include a plurality of light detectors arranged in a row, each of the light detectors detecting light at a different wavelength, such as, for example, at a wavelength for short SWDM functionality. It is noted that not the entirety of the outwardly surface of the carrier layer (110) may include metallization, as it may be advantageous not to include metallization in an optical path of the receive and transmit signals. Accordingly, the metallized surface (110m) may not include portions/regions of the outwardly facing surface of the carrier layer (110) in contact with (optical regions of) the light emitter assembly (110e) or the light detector assembly (110d). Both the light emitter assembly (110e) and the light detector assembly (110d) may be considered electro-optical elements, since they transform a light signal into an electrical signal or vice versa. It may be said that electro-optical elements may be mounted on the bottom, outward facing, or metallized surface (110m) of the transparent carrier substrate.

As shown in FIG. 1A, a transceiver controller (110a), also known as a transceiver ASIC (application specific integrated circuit), may be included on the metallized surface (110m) in close proximity to the light emitter assembly (110e) and the light detector assembly (110d). According to an exemplary embodiment of the present disclosure, the transceiver controller (110a) may include support for at least four channel transmission and reception provided via respective transmitter drivers and receivers. Other components may be included on the metallized surface (110m) of the carrier layer (110), including, for example, OTDR functionality via an OTDR controller (110t). When OTDR functionality is present (e.g., on the transmit side via transmit connector 150t), a corresponding light detector or light emitter may be added to the metallized surface (110m). For example, to support OTDR functionality via the transmit connector (150t), a light detector may be arranged next to, or within, the light emitter assembly (110e), and to support OTDR functionality via the receive connector (150r), a light emitter (e.g., VCSEL) may be arranged next to, or within, the light detector assembly (110d). More details on such arrangements are provided with reference to FIGS. 2-4 later described.

The middle transparent planar layer or lens layer (120) shown in FIG. 1A is arranged atop of the carrier layer (110), and in contact (e.g., bonded) with a top surface of the carrier layer (110) that is oppositely arranged with respect to the bottom metallized surface (110m). The top surface is not metallized in an area where light propagates through the carrier layer (110) but may be metallized in other areas. As shown in FIGS. 2-4 later described, the lens layer (120) includes a transmit lens assembly (120t) that is aligned with the light emitter assembly (110e) and a receive lens assembly (120r) that is aligned with the light detector assembly (110d). The transmit lens assembly may include a plurality of collimating lenses and a focusing lens. The light detector assembly may include a plurality of receive focusing lenses. Alignment of the transmit and receive lens assemblies (120t, 120r) with respect to the light emitter and detector assemblies (110e, 110d) may be such to align optical axes of each of the light emitters (e.g., VCSELs) and light detectors with a respective lens. For example, an optical axis of a light emitter of the light emitter assembly (110e) in the direction z may be aligned (e.g., collinear) with an optical axis of a transmit lens of the transmit lens assembly (120t) in the direction z, and an optical axis of the light detector of the light detector assembly (110d) in the direction z may be aligned with an optical axis of the receive lens of the receive lens assembly (120r) in the direction z. When OTDR functionality is present, a corresponding receive lens or transmit lens may be added to the lens layer (120). For example, to support OTDR functionality via the transmit connector (150t), a receive lens may be arranged next to, or within, the transmit lens assembly (120t), and to support OTDR functionality via the receive connector (150r), a transmit lens may be arranged next to, or within, the receive lens assembly (120r). It should be noted that for OTDR functionality through the receive side, an optical fiber from the transmit side may need to be merged with one from the receive side, and therefore such an arrangement may pose some practicality issues. More details on such arrangements are provided with reference to FIGS. 2-4 later described.

According to an embodiment of the present disclosure, each of the lenses included in the lens layer (120), including the transmit/receive lens assemblies (120t, 120r) and/or lenses for OTDR functionality, may be a collimating lens such as to transform a light beam that originates near the outwardly facing surface of the carrier layer (110) to a parallel beam in the direction z or a focusing lens such as to transform a collimated light beam in the −z direction to a focal point near the outwardly facing surface of the carrier layer (110). In other words, a focal point/distance of each of the lenses included in the lens layer (120), including within the lens assemblies (120t, 120r), may be selected to be near the outwardly facing surface (e.g., metallized surface, 110m) of the carrier layer (110). In this application, near the outwardly facing surface may be within ±100 microns, ±50 microns, or ±10 microns of the outwardly facing surface (110m). The focal point/distance of each of the lenses included in the lens layer (120), may be at an emitting aperture of the light emitter assembly (110e) or at a receiving aperture of the light detector assembly (110d). The emitting aperture of the light emitter assembly (110e) and a receiving aperture of the light detector assembly (110d) may be approximately 15 microns, within 20 microns, within 50 microns, or within 100 microns of the outwardly facing surface (110m), held off the outwardly facing surface (110m) by the electrical attachment mechanism, such as copper pillars or solder balls. Non-collapsible solder balls may be used in the attachment of the light emitter assembly (110e) and the light detector assembly (110d) to help provide a more uniform and controlled spacing between the emitting or detecting aperture and the outwardly facing surface (110m). As the focal point/distance of such lenses may be preset/predetermined, a thickness of the carrier layer (110) may be selected in view of such focal point/distance.

In some instances, it may be desirable to deliberately move the focal point of the lenses away from the emitting aperture of the light emitter assembly (110e) to minimize feedback into the light sources of the light emitter assembly (110c). Feedback can destabilize an output of the light sources reducing contrast in the optical signal. The deliberate positioning of the focal point away from the emitting aperture of the light emitter assembly (110e) may reduce coupling efficiency into the optical fiber, but generally sufficient light will still be coupled into the optical fiber. It may be said that the focal distance of the lenses or the distance of the lenses between the light emitter faces is selected to have a reduced level of feedback while still providing adequate optical coupling to the optical fiber.

According to an embodiment of the present disclosure, the lens layer (120) may be a transparent substrate (120) within which the lenses used for either data communication and/or OTDR functionality, including lens assemblies (120t, 120r), are formed. Such forming of the lenses (e.g., 120t, 120r) may be according to known in the art techniques and processes, including for example, hot molding and etching. It should be noted that although the formed lenses may have different (optical) properties in view of different wavelengths used, more practical implementations, including for support of short SWDM and/or OTDR wherein wavelengths are contained within a narrow spectrum, may include formed lenses with the same optical properties. In other words, according to some exemplary embodiments, all lenses included in the lens layer (120) may be collimating or focusing lenses with the same optical properties.

Similar to the lens layer (120), the carrier layer (110) may be a transparent substrate (110) with at least one metallized surface (110m). According to an embodiment of the present disclosure, the transparent substrates (110, 120) may be of a material including glass or a crystal, such as, for example, sapphire. Such material can provide relatively high mechanical strength as well as support of a wide range of wavelengths for optical transmission and/or reception. It is noted that a material of the transparent substrate (110) may be same as, or different from, a material of the transparent substrate (120).

According to an exemplary embodiment of the present disclosure, the carrier layer (110) and the lens layer (120) may be formed within a single or common transparent substrate, including a top surface within which the lens assemblies (120t, 120r) are formed and a bottom surface that may be metallized. According to a further embodiment of the present disclosure, the single transparent substrate may be used for monolithic integration of the electronic and/or electro-optical components (e.g., 110e, 110d, 110a, 110t, etc.). A person skilled in the art would know of fabrication techniques and processes adapted for such monolithic integration using transparent substrates, such as, for example, sapphire or glass substrates.

The top planar layer or (multichannel) beam splitter/combiner layer (130) shown in FIG. 1A may overlay and be bonded atop the lens layer (120). As shown in FIG. 1A, the beam splitter/combiner layer (130) may include two (multichannel) beam splitter/combiner assemblies (135). A beam splitter assembly is configured to split an optical path (e.g., in the direction y) of an optical signal propagating in a receive optical fiber inserted in the receive fiber connector (150r) to a plurality of separate optical paths (in the direction z) defined by elements of the lens layer (120) and the carrier layer (110) based on a wavelength of the signal. A beam combiner assembly is configured to combine a plurality of separate optical paths (in the direction z) defined by elements of the lens layer (120) and the carrier layer (110) based on a wavelength of the signal into a common optical path (e.g., in the direction y) suitable for coupling into a transmit optical fiber inserted in the transmit fiber connector (150t). This is further explained with reference to FIGS. 2-4 later described. It should be appreciated that the beam splitter assembly and beam combiner assembly may be physically identical, but the direction of propagation of light through the assembly is different. A beam combiner is use on transmit side to combine optical signals transmitted at multiple wavelengths into a single fiber and a beam splitter is used on the receive side to split optical signals received at multiple wavelengths propagating through a single fiber to individual light detectors. In this application the term beam splitter/combiner assembly may refer to the assembly being used as either a beam splitter and/or a beam combiner.

FIG. 1B shows an isometric view of the optical transceiver (100) of FIG. 1A in an assembled state. As shown in FIG. 1B, when assembled, the planar bidirectional optical coupler (1100) is fitted within housing (160) through the bottom opening of the housing, while (e.g., semi-circular) front openings of the housing (160) allow feedthrough of bodies of the fiber connectors (150t, 150r). Also shown in FIG. 1B are assembled/soldered components (e.g., 110e, 110d, 110a, 110t of FIG. 1A) on the metallized surface (110m), as well as a plurality of copper pillars or solder balls (110p) that may be used as electrical inputs/outputs to, for example, a land grid array (LGA) package.

With continued reference to FIG. 1B, according to an exemplary embodiment of the present disclosure, dimensions (i.e., width W and length L) in the (x, y) plane of the housing (160) may be as small as 9 mm by 9 mm. In other words, the width, W, of the housing (160) may be as small as 9 mm, and the length, L, of the housing (160) may be as small as 9 mm and equal to the width, W. Thus, a footprint of the WDM optical interconnect module may be less than 10 mm by 10 mm. According to an exemplary embodiment, a distance between centers of the two fiber connectors (i.e., pitch P of 150t, 150r) may be equal to 6 mm, or in other words, according to a well-known in the art LC (Lucent connector) multimode connector pitch. Accordingly, the optical transceiver (100) may provide a compact packaging that is compliant with industry standard multimode connectors (e.g., 150t and 150r with 1.25 mm ferrule). Such exemplary implementation shown in FIG. 1B may not be considered as limiting the scope of the present teachings, as other form-factors for use with other types of single more or multimode connectors/fibers may also be envisioned. As will be later described, the planar bidirectional optical coupler (e.g., 1100) according to the present disclosure may be used in optical transceivers configured to be coupled to a variety of industry standard or custom fiber connectors that may include one or more transmit optical fibers and/or one or more receive optical fibers.

FIG. 2 shows details (200) of the planar bidirectional optical coupler (1100) in a transmit side of the optical transceiver of FIG. 1A in the assembled state of optical transceiver (i.e., per FIG. 1B). Such details include relative coupling/alignment of the elements (e.g., 110e, 110d, 120r, 120t, 135) within the layers (110, 120, 130) of the assembly (1100), as well as relative coupling/alignment of the assembly (1100) to inner regions (e.g., 150f, 150c, 150h) of the fiber connector (150t). Also shown in FIG. 2, is fitting of a body region (150b) of the fiber connector (e.g., 150t of FIG. 1B) that is fed through the front openings of the housing (160).

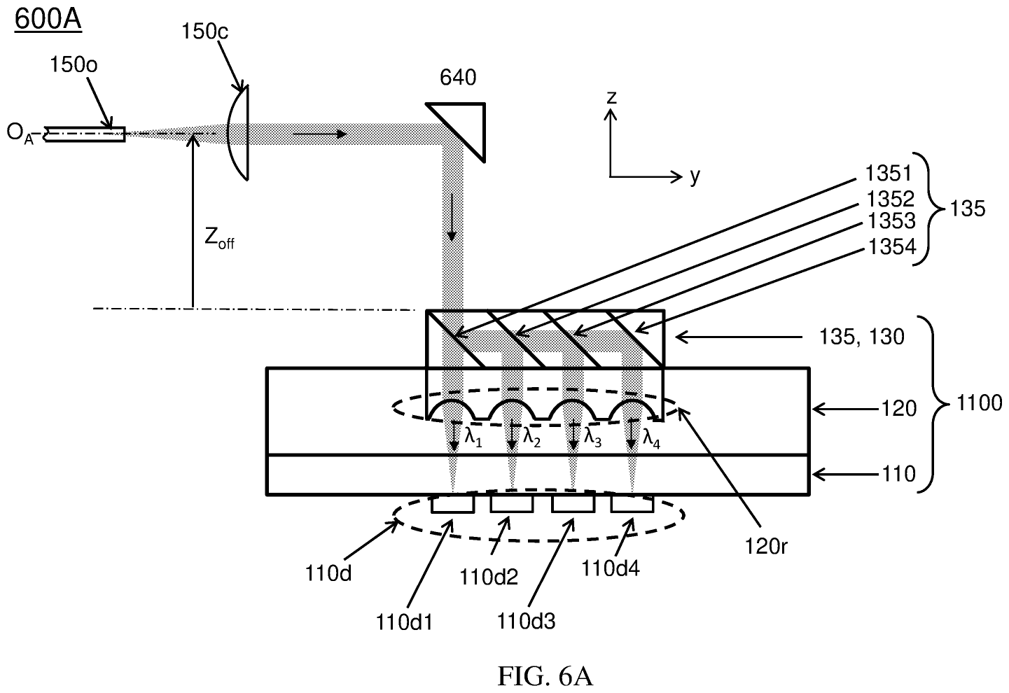

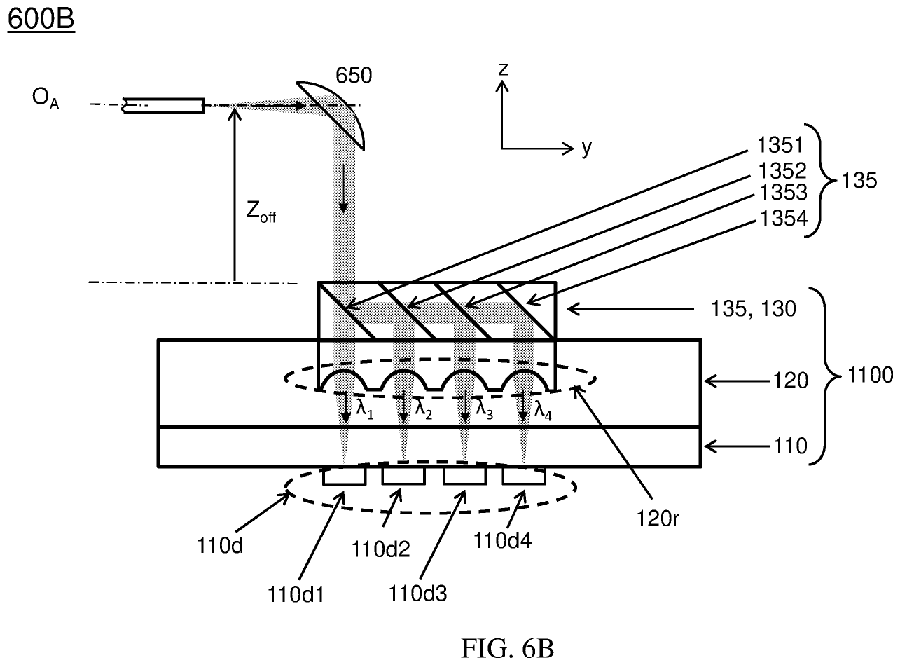

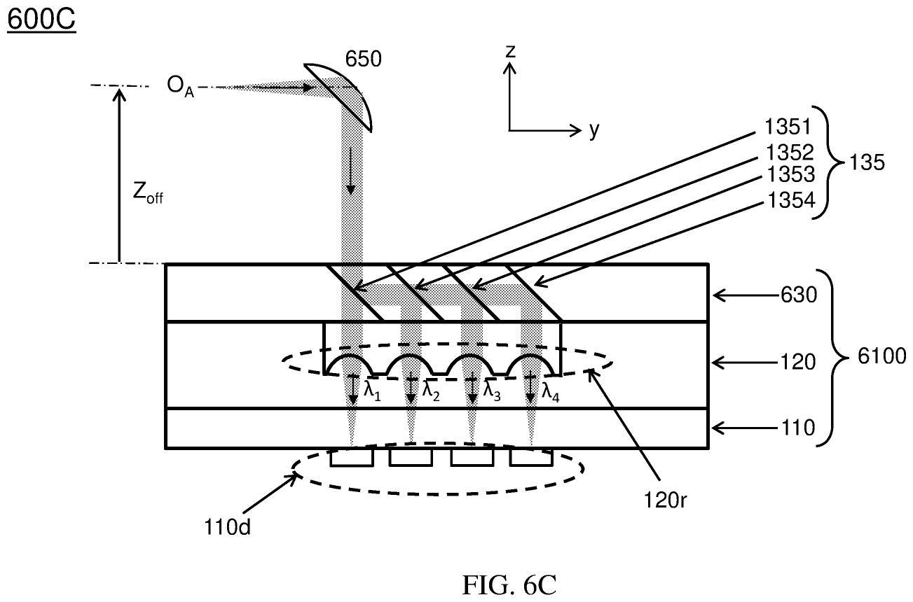

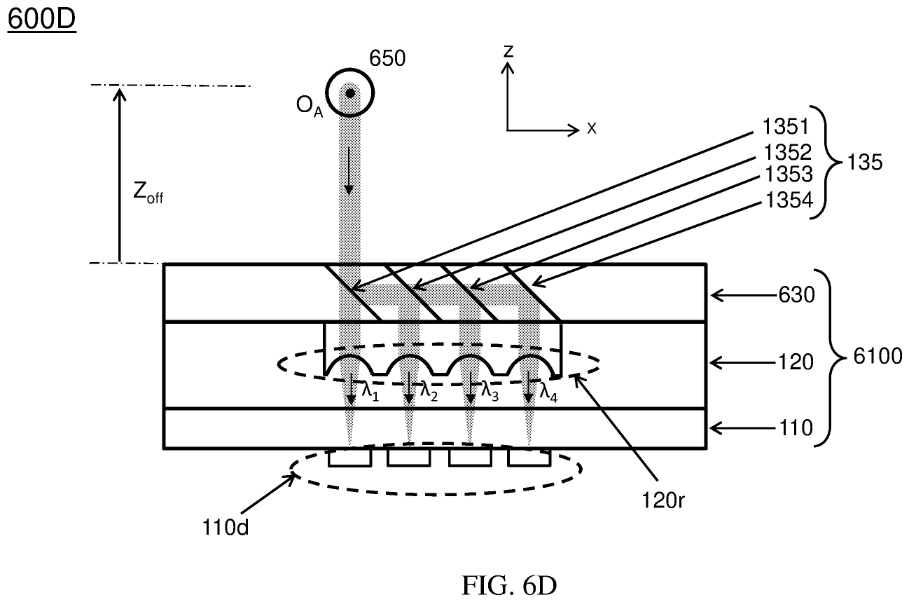

With continued reference to FIG. 2, the transmit optical fiber connector (e.g., 150t of FIG. 1B) may include a molded LC lens portion (150f, 150c, 150h, 150b) that includes the ferrule receptacle (1500 and a fiber coupling lens (150c) which in combination define an optical axis O_{A} through which an optical fiber connected to the fiber connector is guided. As shown in FIG. 2, the optical axis O_{A} extends through the direction y into a housing region (150h) formed within the body region (150b) of the fiber connector. Also shown in FIG. 2 is the beam splitter/combiner assembly (135) fitted within the housing region (150h) such as to present a surface that intersects (e.g., optically aligned) with the optical axis O_{A}. As described above, the planar bidirectional optical coupler (1100) according to the present teachings includes two such beam splitter/combiner assemblies (135), each optically aligned to a respective optical axis O_{A} of the fiber connectors (150t) and (150r). It is noted that in the particular configuration shown in FIG. 2, the optical axis O_{A} is in the direction y and is contained within an (x, y) plane that is common to the beam splitter/combiner assembly (135). As will be later described, such relationship between the optical axis O_{A} and the beam splitter/combiner assembly (135) is not a requirement for coupling of an optical fiber to the planar bidirectional optical coupler (e.g., 1100) according to the present teachings. For example, and with reference to FIGS. 6A-6C, a plane of the optical axis O_{A} may not be a plane common to the beam splitter/combiner assembly (135).

According to an exemplary embodiment of the present disclosure, the beam splitter/combiner assembly (135) of FIG. 2 may be mounted on a (transparent) support substrate (132) that is configured to position the beam splitter/combiner assembly (135) in the direction z alignment with the optical axis O_{A}. Use of the support substrate (132) may depend, for example, on geometries of the molded LC lens portion (150f, 150c, 150h, 150b), including dimensions of the housing region (150h) and relationship to the optical axis O_{A}, as well as, for example, cost constraints of the beam splitter/combiner assembly (135). For example, with a potential cost penalty, one may envision extending the beam splitter/combiner assembly (135) in the direction z thereby avoiding use of the support substrate (132). As another example, one may envision using the lens layer (120) instead of the support substrate (132) for alignment of the beam splitter/combiner assembly (135) in the direction z. Other possible configurations may be envisioned given flexibility in space provided by the housing region (150h).

As shown in FIG. 2, the beam splitter/combiner assembly (135) may include a flat/planar front surface (e.g., contained within an x, z plane) that is (optically) coupled to the ferrule receptacle/fiber coupling lens (150f, 150c) and a flat bottom surface that is (optically) coupled to the lens layer (120). In this context, optically coupled may refer to a contact or contactless interface between respective opposing surfaces such as to cause minimal effect on transmission or reception of an optical signal. In general, the planar bidirectional optical coupler (1100) according to the present teachings includes such optical coupling between adjacent layers, including, between layers (110) and (120), between layers (120) and (130), and between layers (130) and (150f, 150c). Optical coupling may be provided via, for example, contact between two flat surfaces, an air gap between two flat surfaces, or an index-matched (i.e., index of refraction) filler between the two flat surfaces. In some embodiments, optical surfaces of the layers may have an anti-reflection coating.

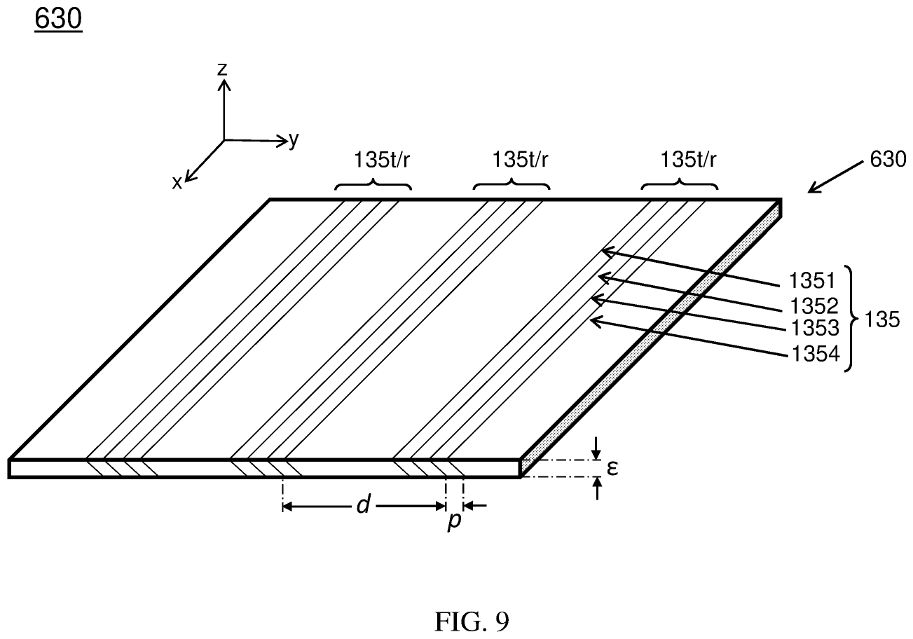

With continued reference to FIG. 2, the beam splitter/combiner assembly (135) may include a plurality of lateral (and flat) surfaces (1351, 1352, . . . , 1355) that are parallel to one another and which form a 45 degrees angle, or some other desired angle, with respect to the direction z, and therefore with respect to the planar top/bottom surfaces of element 135 as well as with respect to the optical axis O_{A}. The lateral surfaces (1351, 1352, . . . , 1355) may be coated to provide multichannel functionality of the beam splitter/combiner assembly (135), including respective transmission and reflection coefficients at different operating wavelengths. The coating may be relatively insensitive to polarization, for example, reflectivity of the coating to s- and p-polarized light may be within ±5%, 10%, 20%, or 30%, of each other. Accordingly, when coated, each of the lateral surfaces (1351, 1352, . . . , 1355) may behave like an optical filter that passes all (operating) wavelengths of light at the exception of one which is reflected. A person skilled in the art will appreciate simplicity in implementation of the beam splitter/combiner assembly (135) using known in the art techniques and processes, including, for example, wafer coating techniques for coating of different substrates for providing the respective surfaces (1351, 1352, . . . , 1355), bonding techniques for (optionally) bonding the different substrates, and dicing/cutting techniques for providing the 45 degrees angled configuration, or whatever orientation is desired, of the surfaces (1351, 1352, . . . , 1355). Same known in the art techniques and processes may be used to implement the beam splitter/combiner layer (630) of FIG. 9 later described, including a plurality of beam splitter/combiner assemblies (e.g., 135t/r) located at different regions/positions of the beam splitter/combiner layer (630).

In other embodiments, an orientation of the plurality of lateral surfaces (1351, 1352, . . . , 1355) may be different than 45 degrees. In such embodiments, light propagating through the lens layer (120) may not be parallel to the z-direction but may be at some angle to the z-direction in the y-z plane. The plurality of lateral surfaces (1351, 1352, . . . , 1355) may be oriented so as to couple light between the carrier layer (110) to the optical axis O_{A}.

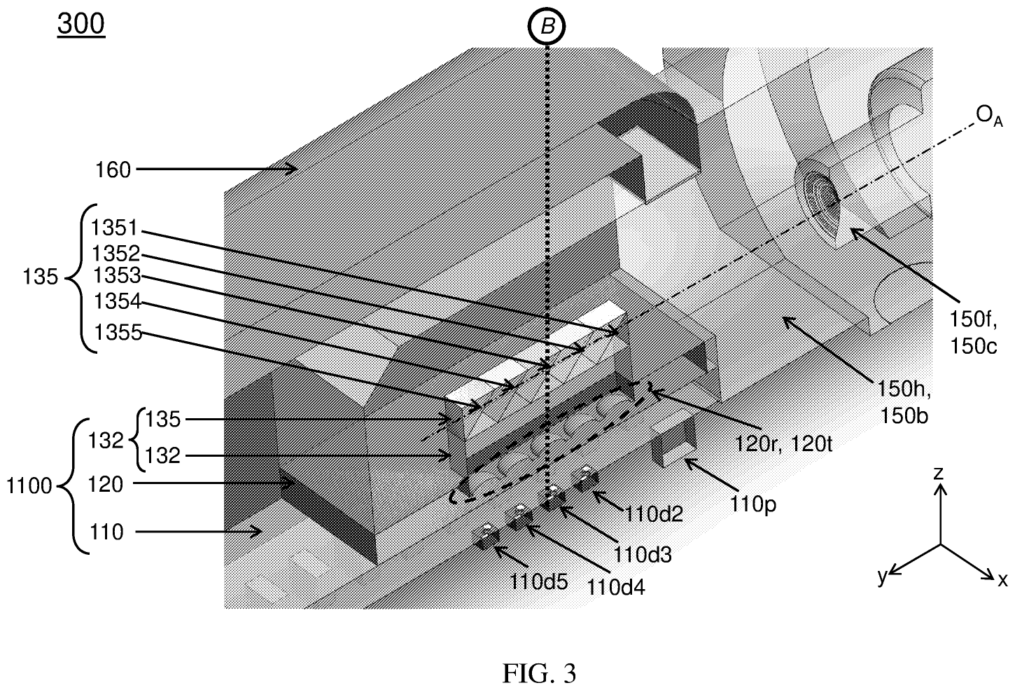

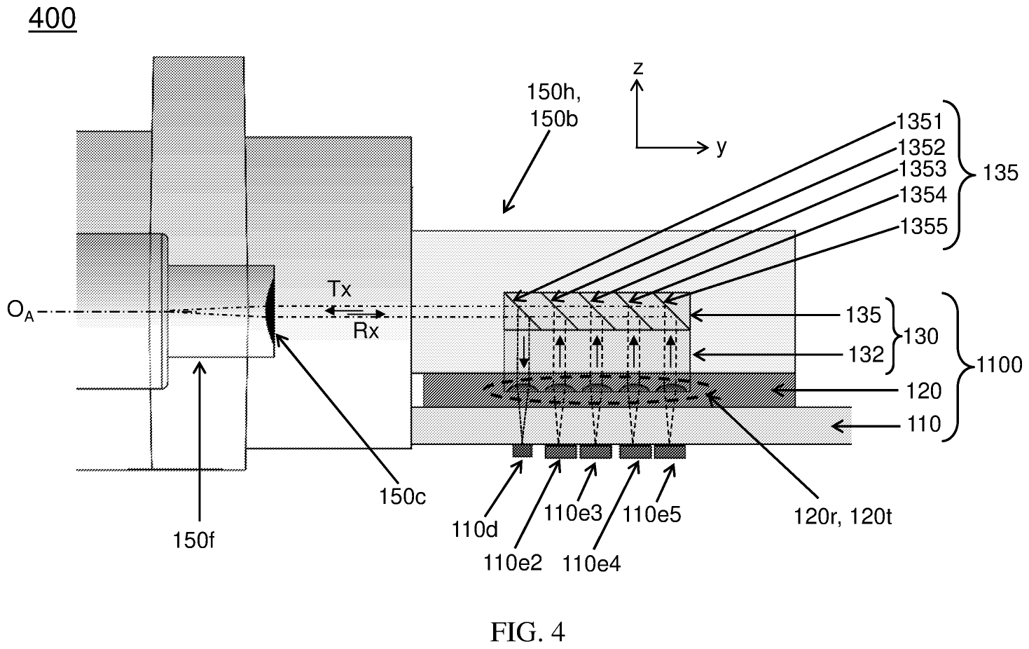

With further reference to FIG. 2, relative arrangement of the carrier layer (110), the lens layer (120) and the beam splitter/combiner layer (130) is such as to provide respective optical paths along the direction z via alignment of a light emitter (e.g., 110e2, 110e3, 110e4, 110e5) of the carrier layer (110), a collimating transmit lens (120t) of the lens layer (120), and a lateral surface (e.g., 1352, 1352, 1354, 1355) of the beam splitter/combiner layer (130). For example, as shown in the detail A of FIG. 2, by aligning an optical axis of the light emitter (110e3) with an optical axis of a corresponding collimating lens (third lens from left of the encircled region in layer 120), a light signal emitted from the light emitter (110e3) is collimated by the corresponding collimating lens in the direction z, and reflected by the corresponding lateral surface (1353) for transmission along the optical axis O_{A}. More details of respective optical paths of emitted optical signals through the planar bidirectional optical coupler (1100) are shown in FIG. 4 later described. It is noted that in FIG. 2 (as well as in FIG. 3), elements of the carrier layer (110), including light emitters (e.g., 110e2, . . . ) and light detectors (e.g., 110d, . . . ) are represented by corresponding (pairs of) solder pads for soldering of the light emitters and detectors. Also shown in FIG. 2 is an exemplary profile of a copper pillar or solder ball (110p) described above. The light emitters (e.g., 110e2, . . . ) and light detectors (e.g., 110d, . . . ) may be said to be flip-chip mounted to the metallized surface (110m) of the carrier layer (110).

As shown in FIG. 2, OTDR functionality may be provided via inclusion of a light detector (110d) in the carrier layer (110), an optical axis of the light detector (110d) aligned with an optical axis of a corresponding collimating lens (first lens from left of the encircled region in layer 120), and further aligned with the first lateral surface (1351) of the beam splitter/combiner layer (130). The first lateral surface (1351) may be coated such as to reflect incoming incident light along the optical axis O_{A} at one or more of the (operating) wavelengths to the light detector (110d). The first lateral surface (1351) may have a reflectivity of 50% for incident light, although higher or lower reflectivities may be used. Accordingly, during an OTDR measurement cycle, a portion of the light emitted (e.g., light pulses, light timing pulses) at the one or more wavelengths via a corresponding light emitter (110e2, 110e3, 110e4, 110e5) is transmitted into an optical fiber coupled to the ferrule receptacle (150f), and corresponding reflections are received along the optical axis O_{A} and a portion reflected by the first lateral surface (1351) for detection by the light detector (110d). More details of an optical path of a received optical signal through the planar bidirectional optical coupler (1100) are shown in FIG. 4 later described. A time delay between the emitted and detected light pulse may be used as a signal in the optical time domain reflectometer to determine a distance from the WDM optical interconnect module to a fault in an optical fiber communication network.

FIG. 3 shows details (300) of the planar bidirectional optical coupler (1100) in a receive side of the optical transceiver of FIG. 1A in the assembled state of the optical transceiver (i.e., per FIG. 1B). Such details include relative coupling/alignment of the elements (e.g., 110d, 120r, 120t, 135) within the layers (110, 120, 130) of the assembly (1100), as well as relative coupling/alignment of the assembly (1100) to inner regions (e.g., 150f, 150c, 150h) of the fiber connector (150r). Also shown in FIG. 3, is fitting of a body region (150b) of the receive fiber connector (e.g., 150r of FIG. 1B) that is fed through the front openings of the housing (160).

It is noted that the receive side configuration (300) of FIG. 3 includes details similar to the details described above with reference to the transmit side configuration (200) of FIG. 2, wherein like numerals and reference designators refer to like elements. In particular, differences between the two configurations (200, 300) include use of light detectors (110d2, 110d3, 110d4, 110d5) in the configuration (300) of FIG. 3 instead of the light emitters (110e2, 110e3, 110e4, 110e5) in the configuration (200) of FIG. 2, as well as the absence of an optional OTDR functionality in the configuration (300) of FIG. 3. In other words, based on the above description with reference to FIG. 2, a person skilled in the art would clearly understand the details of the receive side configuration (300) of FIG. 3.

As shown in FIG. 3, the receive side configuration (300) may include a beam splitter/combiner assembly (135) and focusing lenses within the lens layer (120) that are similar to their counterparts described above with reference to FIG. 2. For example, as shown in the detail B of FIG. 3, by aligning an optical axis of a light detector (110d3) with an optical axis of a corresponding collimating lens (third lens from left of the encircled region in layer 120), a (collimated) light signal received along the optical axis O_{A} is reflected by the corresponding lateral surface (1353) into the direction z and focused onto the light detector (110d3) through the corresponding focusing lens. In this case, a wavelength of the received light signal passes through the lateral surfaces (1351, 1352) before being reflected by the lateral surface (1353). As described above, each of the lateral surfaces (1351, 1352, . . . , 1355) may reflect only one of the operating wavelengths and pass the other ones. It is noted that since OTDR functionality may not be provided in the receive side, it may be possible to alter the configuration (300) shown in FIG. 3 to exclude one focusing lens from the lens layer (120) as well as a corresponding lateral surface (e.g., 1351) from the beam splitter/combiner assembly (135).

FIG. 4 shows details (400) of optical paths provided by the planar bidirectional optical coupler (1100) in the transmit side of the optical transceiver of FIG. 1A in the assembled state of optical transceiver (i.e., per FIG. 1B). These include optical paths for emission of optical signals from each of the light emitters (110e2, 110e3, 110e4, 110e5) through corresponding collimating (transmit) lenses (120t) of the lens layer (120), and reflected by corresponding lateral surfaces (1352, 1353, 1354, 1355) of the beam splitter/combiner assembly (135) for transmission (e.g., Tx) along the optical axis O_{A} of an optical fiber coupled to the ferrule receptacle (150f). Furthermore, FIG. 4 shows an optical path for receiving a (reflected) optical signal (e.g., Rx) along the optical axis O_{A}, the optical signal reflected by the first lateral surface (1351) and focused onto the light detector (110d) through a corresponding focusing (receive) lens (120r) of the lens layer (120). As described above with reference to FIG. 2, such received optical signal (e.g., Rx) may be a reflected signal from the optical fiber coupled to the ferrule receptacle (150f) initially generated by emission from one or more of the light emitters (110e2, 110e3, 110e4, 110e5). The ferrule receptacle (150f) may be suitable for coupling to a multimode optical fiber or a single mode optical fiber. While not shown, it should be appreciated that lateral surface 1351 will reflect a portion of the light emitted by light emitters (110e2, 110e3, 110e4, 110e5) upward and will transmit a portion of the reflected optical signal (Rx) along the optical axis O_{A}. Upwardly reflected light from lateral surface 1351 may go into a beam dump (not shown in FIG. 4) where it is absorbed. The lateral surface 1351 thus serves as a beam attenuator for optical signals emitted by light emitters (110e2, 110e3, 110e4, 110e5). Attenuating the optical signals is often advantageous, since it can avoid inducing non-linearities during light propagation in the optical fiber and avoid detector saturation on a receiving end of the optical signals. For example, the lateral surface (1351) may reflect approximately 50% of the incident light, attenuating the optical signals by approximately 3 dB.

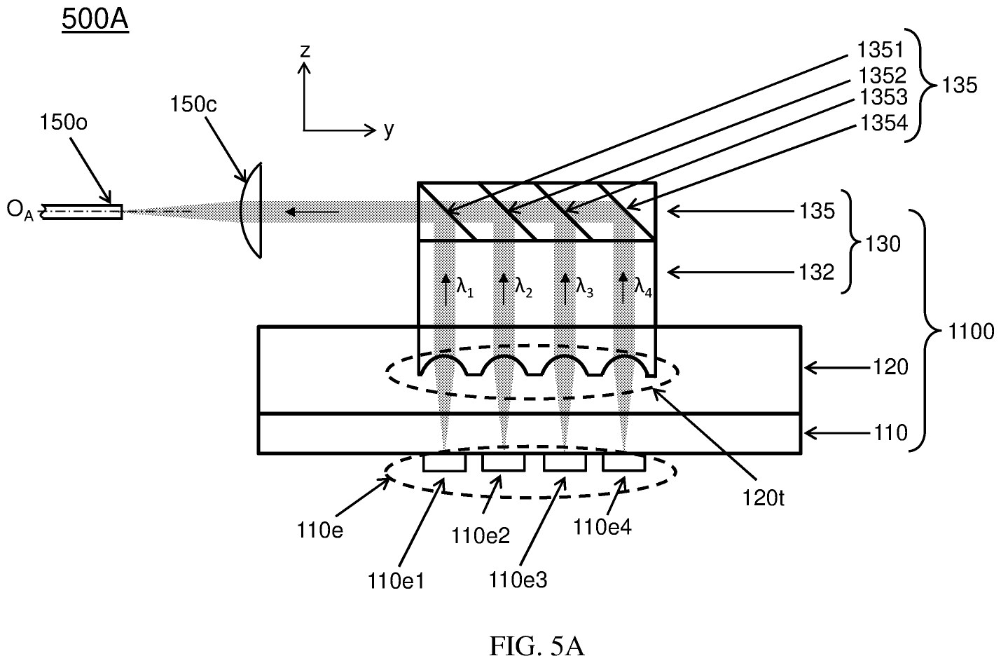

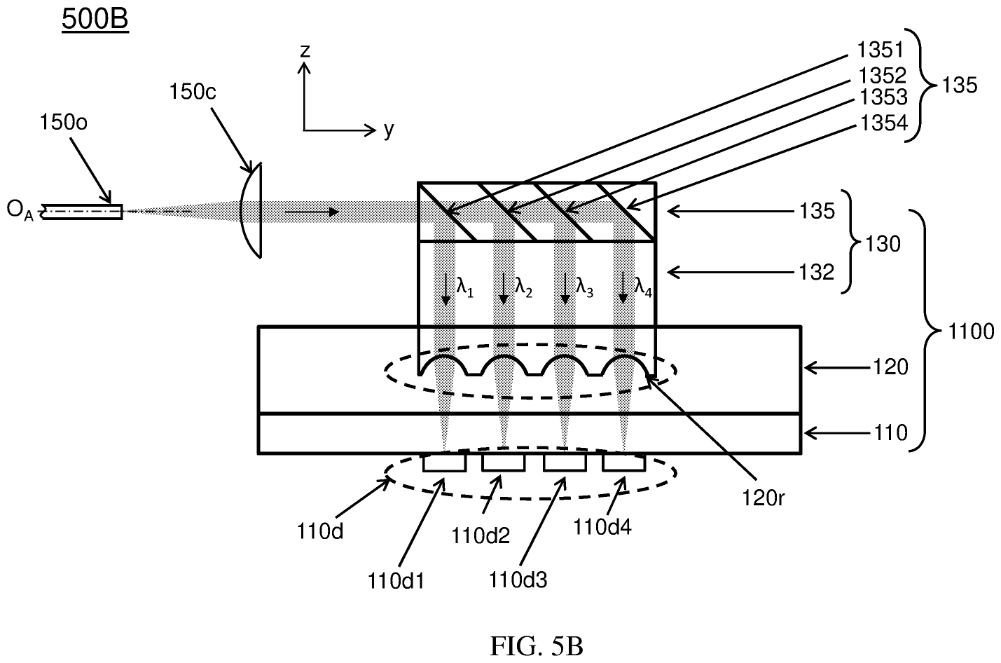

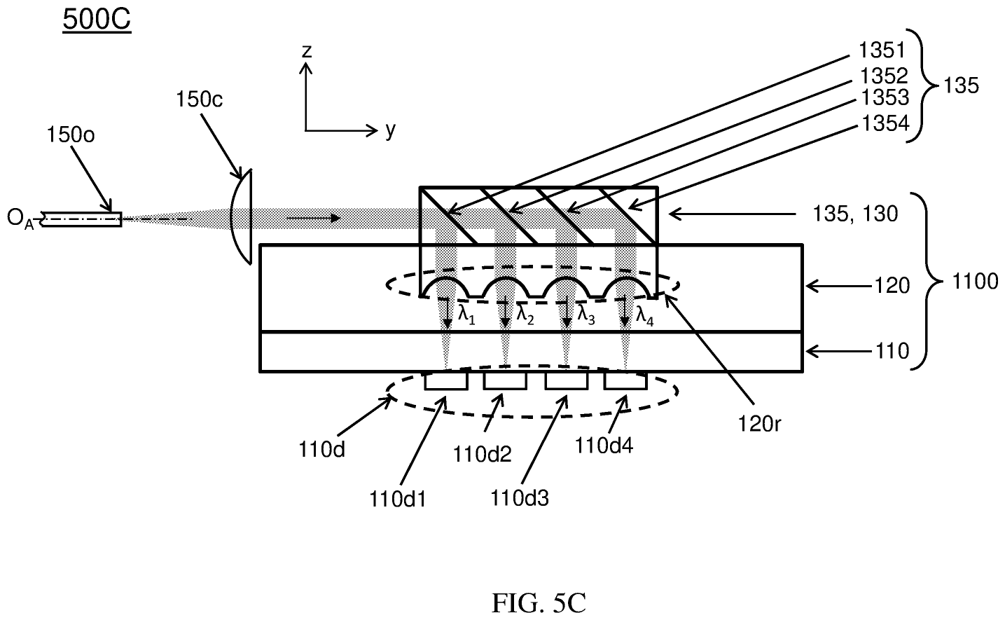

FIG. 5A shows details (500A) of optical paths in a transmit side of an optical transceiver (e.g., 100 of FIG. 1A) comprising the planar bidirectional optical coupler (1100) according to the present disclosure. In the configuration shown in FIG. 5A, the optical transceiver (e.g., 100 of FIG. 1A) is configured to be coupled to an optical fiber (150o) having an optical axis O_{A} that is contained within an (x, y) plane of the planar bidirectional optical coupler (i.e., of the beam splitter/combiner assembly 135). In particular, as shown in the FIG. 5A, the optical axis O_{A} intersects a (lateral) surface of the beam splitter/combiner assembly (135) in the (x, z) plane. Such arrangement of the optical paths shown in FIG. 5A may be considered as an exemplary arrangement for coupling of the transmit and receive optical fiber connectors (e.g., 150t, 150r of FIG. 1A) to the planar bidirectional optical coupler (1100). However, such arrangement should not be considered as limiting the scope of the present disclosure, as other arrangements suitable for coupling other types of optical fiber connectors to the planar bidirectional optical coupler (1100) may be envisioned. One such arrangement is described in the ensuing figures. It is noted that although the exemplary configuration shown in FIG. 5A, includes a light source or light emitter assembly (110e) for emitting light at four different wavelengths (e.g., λ₁, λ₂, λ₃, λ₄), such light emitter assemblies may include more or fewer light emitters (e.g., 110e1, 110e2, 110e3, 110e4) for emitting more or less different wavelengths. Furthermore, as described above with reference to, for example, FIGS. 2-4, if desired, OTDR functionality may be included in the configuration shown in FIG. 5A.

The optical fiber (150o) may be detachable using an optical connector, such as a LC connector as previously described. Other types of optical connectors, such as but not limited to, MT style connectors may be used. Alternatively, the optical fiber (150o) may be permanently attached to the optical transceiver (100) in a so-called fiber pigtail.

FIG. 5B shows details (500B) of optical paths in a receive side of the optical transceiver discussed above with reference to FIG. 5A. Similar to the configuration shown in FIG. 5A, the optical axis O_{A} (here in an opposite direction from one shown in FIG. 5A) intersects the surface of the beam splitter/combiner assembly (135) in the (x, z) plane. It is noted that the receive side configuration (500B) of FIG. 5A includes details similar to the details described above with reference to the transmit side configuration (500A) of FIG. 5A, wherein like numerals and reference designators refer to like elements.

FIG. 5C shows an alternative configuration (500C) of the planar bidirectional optical coupler that may be used in the optical transceiver described above with reference to FIG. 5A and FIG. 5B. In particular, as shown in FIG. 5C, the transparent support substrate (132) present in the beam splitter/combiner layer (130) of FIGS. 5A-5B may be omitted, while maintaining a coincidence between the optical axis O_{A} and a (lateral) surface of the beam splitter/combiner assembly (135) in the (x, z) plane. It is noted that the beam splitter/combiner layer (130) may extend laterally such as to provide a larger planar profile, such as for example, one that substantially matches the planar profile of the layers below (e.g., 110, 120). This is shown in FIG. 6C later described.

FIG. 6A shows details (600A) of optical paths in a receive side of an optical transceiver comprising the planar bidirectional optical coupler (1100) of FIG. 5C, the optical transceiver coupled to an optical fiber (150o) having an optical axis O_{A} that is not contained within a plane of the planar bidirectional optical coupler. In particular, as shown in FIG. 6A, the optical axis O_{A} may be contained in an (x, y) plane that is offset by an amount Z_{off} in the direction z with respect to an (x, y) plane of the beam splitter/combiner assembly (135). In the configuration shown in FIG. 6A, the fiber coupling lens (150c) is a collimating lens, that may be part of an optical fiber connector (not shown in FIG. 6A), collimates a received light onto a (45 degrees) optical mirror (640) which reflects the received light (from the direction y) onto the direction z for coincidence with a top surface (i.e., in a plane x, y) of the beam splitter/combiner assembly (135 part of layer 130). The optical mirror (640) may be arranged such as to align (in the direction y) the reflected light with a first lateral surface (1351) of the beam splitter/combiner assembly (135), and therefore with a corresponding (receive focusing) lens of the receive lens layer (120r) and a corresponding light detector (e.g., 110d1) of the light detector assembly (110d).

With continued reference to FIG. 6A, the configuration (600A) can provide a wavelength division multiplexing (e.g., SWDM) functionality similar to one described above with reference to FIGS. 1-5. In particular, the lateral surfaces (1351, 1352, . . . , 1354) may be coated to provide multichannel functionality of the beam splitter/combiner assembly (135), including respective transmission and reflection coefficients at different operating wavelengths. Accordingly, when coated, each of the lateral surfaces (1352, 1353, 1354) may behave like an optical filter that passes/transmits all (operating) wavelengths (e.g., λ₂, λ₃, λ₄) of light at the exception of one which is reflected for further processing by elements (e.g., 110d2, 110d3, 110d4) of the carrier layer (110), whereas the first lateral surface (1351) may behave like an optical filter that reflects all (operating) wavelengths of light with the exception of one (e.g., λ₁) which is transmitted through the surface for further processing by a corresponding element (e.g., 110d1) of the carrier layer (110). It is noted that a coating provided to the last lateral surface (e.g., 1354) may provide functionality of a filter as described above, or it may be a mirror reflecting all wavelengths as no other light is required to pass through such last lateral surface. It may be said that the last lateral surface, that is the lateral surface (1354) furthest from where wavelength division multiplexed light enters or exits the beam splitter/combiner assembly (135) is not wavelength selective in its reflective properties. It is further noted that a transmit side configuration that is the dual of the receive side configuration shown in FIG. 6A can be clearly envisioned based on the entirety of the description above. As previously noted, each such receive side or transmit side configuration may include OTDR functionality through a corresponding/dedicated lateral surface of the beam splitter/combiner assembly (135).

FIG. 6B shows details (600B) of an alternative configuration for providing the optical paths shown in FIG. 6A. In particular, in the configuration shown in FIG. 6B, functionality of the fiber coupling lens (150c) and the optical mirror (640) of FIG. 6A is combined into a single fiber coupling mirror (650). A person skilled in the art is well aware that such an optical component may be used for turning and collimating incident light. In some implementations, such functionality may be provided via a curved mirror (e.g., 650) as shown in FIG. 6B. Advantages of using such fiber coupling mirror may include a reduction in assembly size via a lesser number of components, a reduction in optical path length, a reduction in optical alignment complexity, all of which may provide for a more compact and less expensive optical fiber connector (fitted with the fiber coupling mirror 650). The fiber coupling mirror 650 shown in FIG. 6B is a second surface mirror, but a first surface mirror may alternatively be used.

FIG. 6C shows an alternative configuration (600C) of a beam splitter/combiner layer (630) used in a planar bidirectional optical coupler (6100) according to the present disclosure, wherein the beam splitter/combiner layer (630) includes a planar profile (i.e., footprint in the x, y plane) that substantially matches the planar profile of the layers below (e.g., 110, 120). FIG. 9, later described, shows an isometric view of such a beam splitter/combiner layer. Extent of the planar profile of the beam splitter/combiner layer (e.g., 130 of FIG. 6B or 630 of FIG. 6C) may be considered a design choice and based, for example, on a target optical fiber connector and a size constraint of the bidirectional optical coupler (e.g., 1100 of FIG. 6B or 6100 of FIG. 6C).

FIG. 6D shows an alternative configuration (600D) wherein the surfaces (e.g., 1351, . . . , 1354) of the beam splitter/combiner layer (e.g., 630) are oriented differently from the configuration shown in FIG. 6C. In particular, the surfaces (e.g., 1351, . . . , 1354) shown in FIG. 6D reflect (a portion of) light from the direction z to the direction x, whereas in the configuration of FIG. 6C, the surfaces (e.g., 1351, . . . , 1354) reflect (a portion of) light from the direction z to the direction y. In other words, the surfaces (e.g., 1351, . . . , 1354) shown in FIG. 6D are arranged in parallel with respect to one another and along the direction x, whereas in the configuration of FIG. 6C, the surfaces (e.g., 1351, . . . , 1354) are arranged in parallel with respect to one another but along the direction y. Such arrangement of the surfaces (e.g., 1351, . . . , 1354) of the beam splitter/combiner layer (135) may be considered a design choice and based, for example, on a target optical fiber connector (e.g., number of optical fibers) and a size constraint of the bidirectional optical coupler (6100).

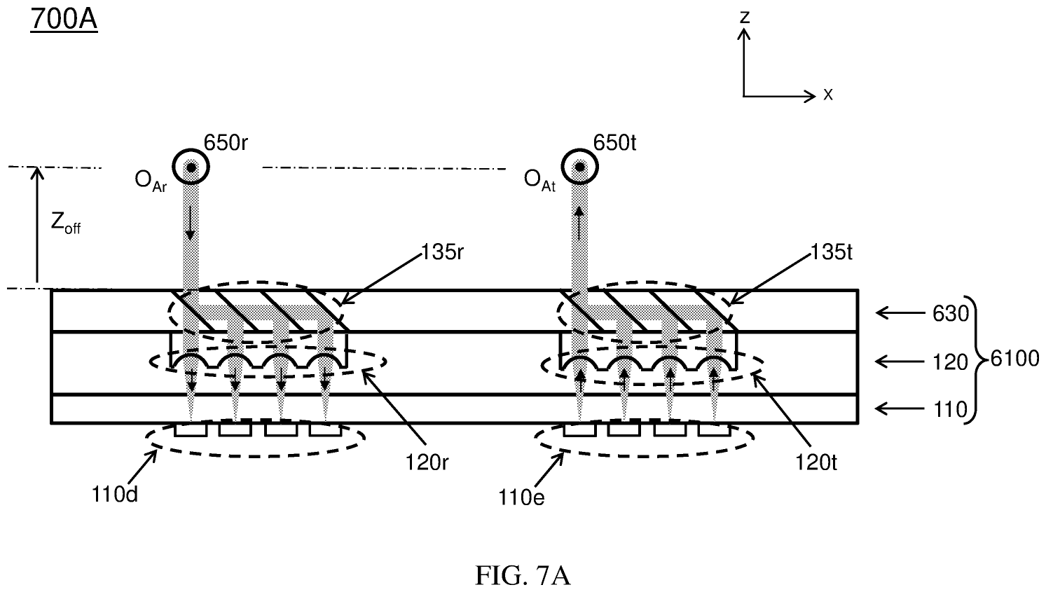

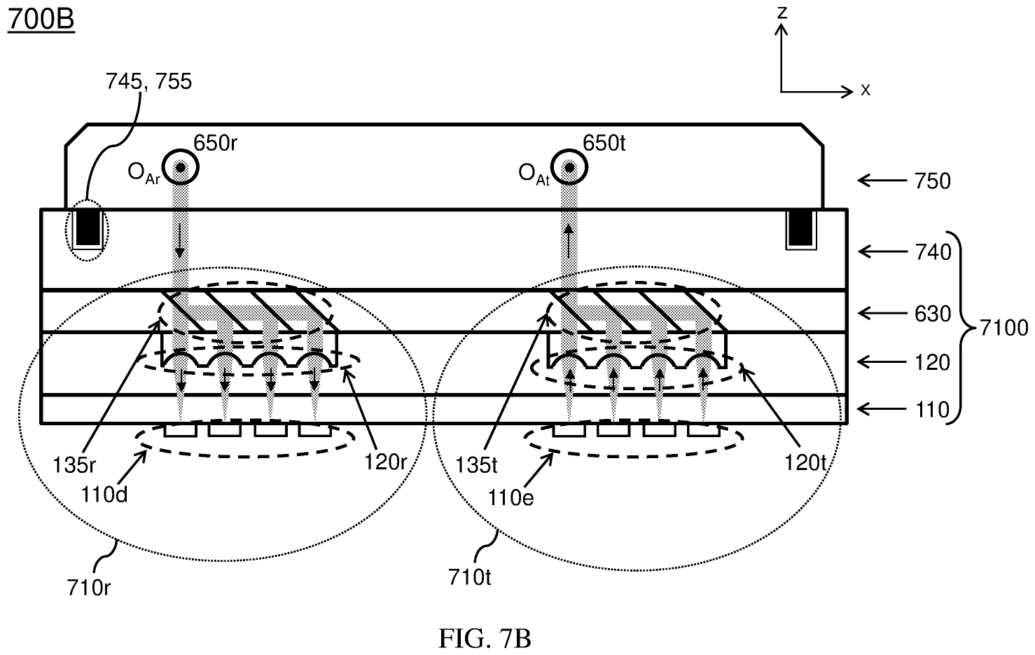

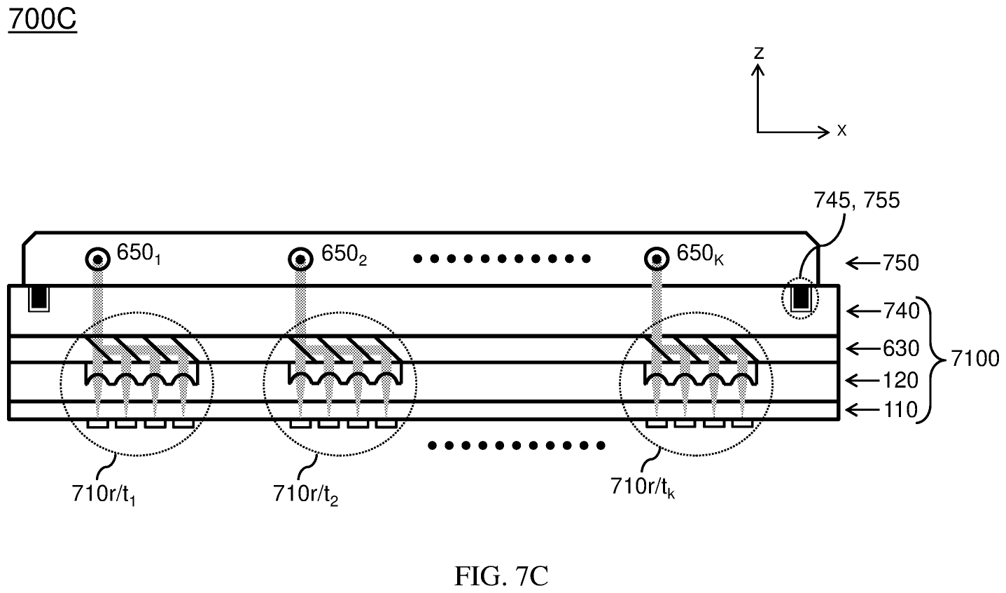

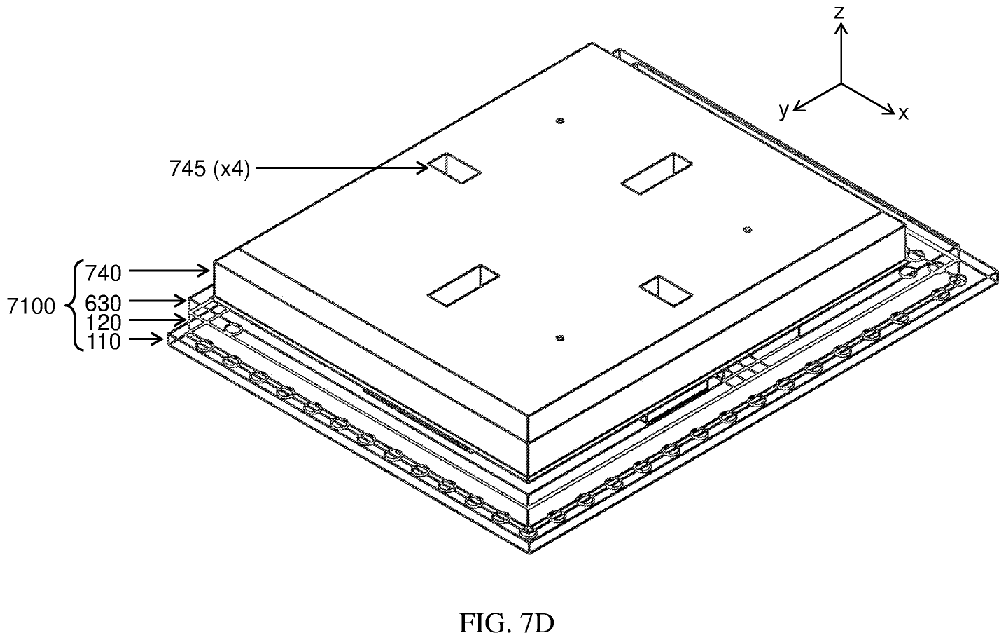

FIG. 7A shows details (700A) of optical paths in a transmit side and a receive side of an optical transceiver according to the present disclosure based on the planar bidirectional optical coupler (6100) of FIG. 6D. The configuration shown in FIG. 7A shows the receive side of the optical transceiver described above with reference to FIG. 6D implemented via a respective receive beam splitter/combiner assembly (135r) formed in the beam splitter/combiner layer (630), and a transmit side of the optical transceiver implemented via a respective transmit beam splitter/combiner assembly (135t) formed in the beam splitter/combiner layer (630). As shown in FIG. 7A, the optical transceiver is coupled to respective receive and transmit optical fibers (e.g., through fiber coupling mirrors, receive collimating mirror 650r and transmit focusing mirror 650t) having respective optical axes (O_{Ar}, O_{At}) contained in an (x, y) plane that is offset by an amount Z_{off} in the direction z with respect to an (x, y) plane of the beam splitter/combiner layer (630). It is noted that as shown in FIG. 7A, such offset may be referenced to a top surface of the beam splitter/combiner layer (630). It is further noted that although the configuration of FIG. 7A shows the respective optical axes (O_{Ar}, O_{At}) contained in a same (x, y) plane, such configuration should not be considered as limiting the scope of the present disclosure as each of the respective optical axes (e.g., O_{Ar}, O_{At}) may be arranged at different offsets in the direction z with respect to the beam splitter/combiner layer (630). It is further noted that orientation of the surfaces (e.g., 1351, . . . , 1354 shown in FIG. 6C-6D) of the beam splitter/combiner layer (630) may be according to any one orientation described above with reference to FIG. 6C or FIG. 6D.

FIG. 7B shows coupling of a planar fiber connector (750) to the optical transceiver of FIG. 7A. As shown in the configuration (700B) of FIG. 7B, the planar fiber connector (750) may include receive collimating mirror (650r) and transmit focusing mirror (650t) that optically couple respective optical fibers having optical axes (O_{Ar}, O_{At}) to the layers (110, 120, 630 also shown in FIG. 7A) of the planar bidirectional optical coupler (7100) through a (planar) layer (740). The planar bidirectional optical coupler (7100) shown in FIG. 7B may be considered as the planar bidirectional optical coupler (6100) of FIG. 7A with an additional (top) layer (740) that is used for direct interface/coupling with the planar fiber connector (750). In particular, as shown in FIG. 7B, the planar fiber connector (750) may include mechanical protrusions (e.g., 755) that are mated to complementary recessed regions (e.g., 745) formed in the top surface of the layer (740). In other words, alignment of the planar fiber connector (750) to the planar bidirectional optical coupler (7100) may be provided by mechanical interferences (745, 755) formed in respective surfaces of the connector (750) and the coupler (740). As shown in FIG. 7B, at least two such interferences (745, 755) may be provided.

With continued reference to FIG. 7B, the additional layer (740) may be referred to as a lens guide layer (740) formed by a transparent material in the sense described above. This may include, for example, glass or a crystal such as sapphire. It should be noted however that a crystal may pose some issues in forming of the mechanical interference (745) into the lens guide layer (740). According to an embodiment of the present disclosure, the various layers (110, 120, 630, 740) may be matched in their respective index of refraction.

As shown in FIG. 7B, the lens guide layer (740) guides light from the planar optical fiber connector (750) to a receive side (710r) of the transceiver, and guides light from the transmit side (710t) of the transceiver to the planar optical fiber connector (750). It is noted that although the exemplary configuration (700B) of FIG. 7B shows one pair receive/transmit side (710r, 710t), teaching according to the present disclosure may equally apply to any number of pairs (710r, 710t), or any number or combination of receive side (710r) and/or transmit side (710t). It is further noted that although the lens guide layer (740) may facilitate mating of the planar optical fiber connector (750) to the layers (110, 120, 630) of the planar bidirectional optical coupler (7100), presence of the lens guide layer (740) may not be considered as limiting the scope of the present teachings as configurations not using the layer (740) and including alignment patterns/interferences on a top surface of the beam splitter/combiner layer (630) may be envisioned.

FIG. 7C shows a configuration (700C) including a plurality of receive or transmit sides (710r/t₁, 710r/t₂, . . . , 710r/tₖ) coupled to the planar optical fiber connector (750). In particular, each element (710r/t₁, 710r/t₂, . . . , 710r/tₖ) shown in FIG. 7A may be a receive side (e.g., 710r of FIG. 7B) or a transmit side (e.g., 710t of FIG. 7B) of a transceiver that is coupled to an optical fiber of the planar optical fiber connector (750) via a respective fiber coupling mirror (650₁, 650₂, . . . , 650ₖ). Thus, instead of just a transmit and a receive fiber, which would connect to transmit and receive optical fiber connectors (150t, 150r), respectively, of the bidirectional planar WDM optical interconnect module (1100) shown in FIG. 1A, the planar bidirectional optical coupler (7100) is configured to accept one or more additional fibers. Each additional fiber would be in optical alignment with a respective fiber coupling mirror (650₁, 650₂, . . . , 650ₖ). The additional fibers may be associated with either an additional transmit fiber or an additional receive fiber.

FIG. 7D shows details of an alignment pattern that may be comprised in the planar bidirectional optical coupler (7100). As described above, such alignment pattern may include a plurality of recesses (745) formed in the (top surface of the) lens guide layer (740) and configured as mechanical interferences to the planar optical fiber connector (e.g., 750 of FIG. 7C). It is noted that although FIG. 7D shows four recesses (745) of rectangular profile, more or less recesses with different profiles may also be envisioned. It is noted that a polarity of the mechanical interferences between the lens guide layer (740) and the planar optical fiber connector (e.g., 750 of FIG. 7C) may be reversed. In other words, the lens guide layer (740) may include protrusions and the connector may include recesses.

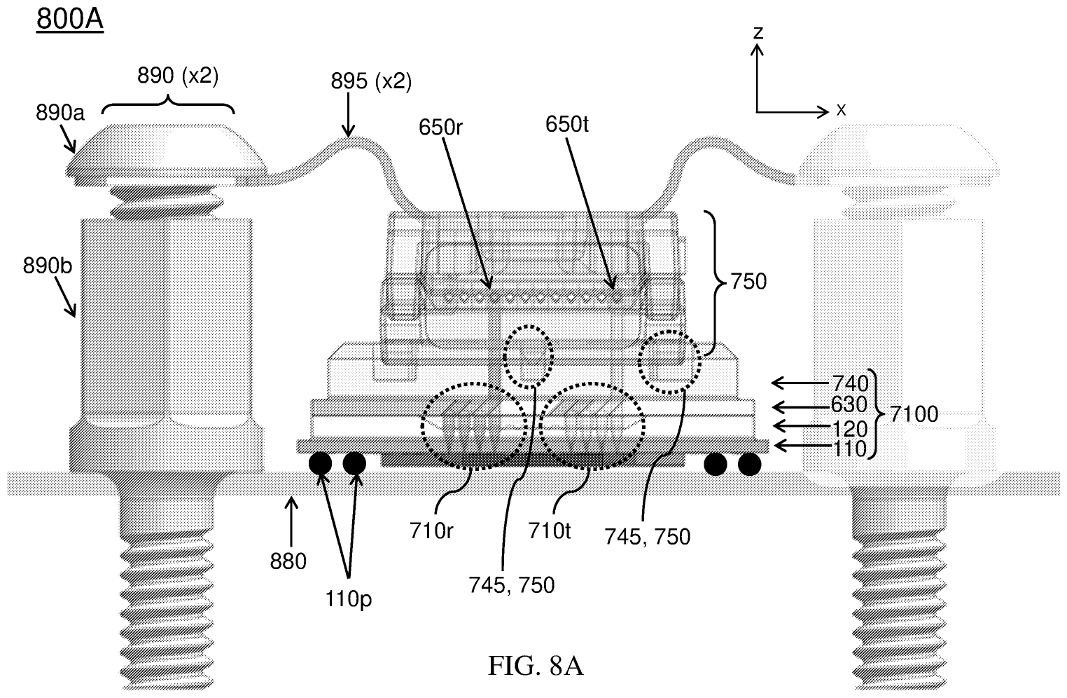

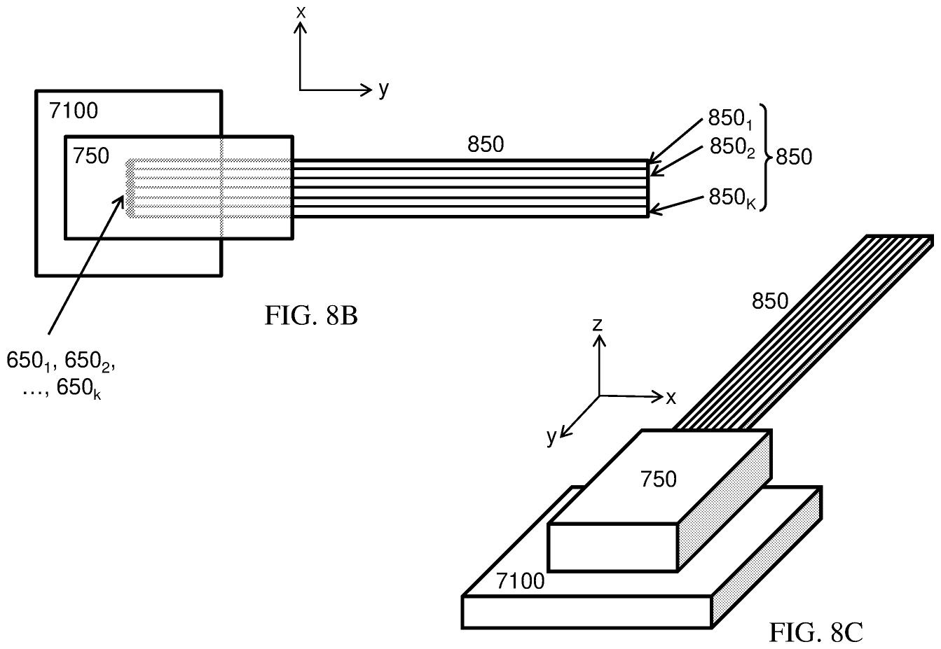

FIG. 8A shows assembly details (800A) of an exemplary planar fiber connector (750) coupled to the planar bidirectional optical coupler (7100) of the optical transceiver of FIG. 7A. As shown in FIG. 8A, the optical transceiver (e.g., including 7100) may be mounted on a host printed circuit board (880) via a plurality of copper pillars or solder balls (110p). Furthermore, the planar fiber connector (750) may include straps (895) that are fixed to respective standoffs (890) mounted on the printed circuit board (880) such as to maintain/fixate location of the connector (750) in its connected (as shown in FIG. 8A) or disconnected state. As shown in FIG. 8A, fixating of the strap (895) to the standoff (890) may be provided via a screw (890a) that is tightened within threads formed inside of a main body (890b) of the standoff (890). It is noted that the exemplary planar fiber connector (750) shown in FIG. 8A may be any known in the art or a custom connector, including, for example, the known in the art RVCON™ (Rugged Vertical CONnector) type connector.

FIG. 8B and FIG. 8C show respective top and isometric views of the configuration shown in FIG. 7C. As shown in such figures, the planar fiber connector (750) may be coupled to an optical fiber cable (850) comprising a plurality of optical fibers (850₁, 850₂, . . . , 850ₖ) coupled to the respective fiber coupling mirrors (650₁, 650₂, . . . , 650ₖ) of the planar fiber connector (750). According to an exemplary embodiment of the present disclosure, the optical fiber cable (850) may be an optical fiber ribbon type comprising optical fibers (850₁, 850₂, . . . , 850ₖ) having each a fiber core and fiber cladding. The fiber core may be a single mode or multimode core. Typical multimode core diameters include, but are not limited to, 50 μm, 62.5 μm, and 80 μm. Single mode core diameters are significantly smaller having diameters in the 5 to 10 μm range.

FIG. 9 shows an isometric view of the beam splitter/combiner layer (630) that may be used in the configuration (700C) of FIG. 7C. As shown in FIG. 9, a plurality of beam splitter/combiner assemblies (e.g., labelled as 135t/r) may be formed within the beam splitter/combiner layer (630) having a thickness ε, each beam splitter/combiner assembly (135t/r) having a plurality of coated lateral surfaces (e.g., 1351, . . . , 1354) adjacent one another according to, for example, a pitch p. Furthermore, as shown in FIG. 9, any two consecutive beam splitter assemblies (135t/r) may be positioned at a relative distance d. A person skilled in the art would clearly realize that optical performance of the plurality of beam splitter/combiner assemblies (135t/r) may be insensitive to dimensions ε, p and d. In other words, in order to comply to requirements of a specific optical fiber connector (e.g., 750 of FIG. 7C), parameters/dimensions ε, p and d may be adjusted with essentially no impact on performance of the transceiver according to the present disclosure. This may include, for example, constant or non-constant pitch p for any given beam splitter/combiner assembly (135t/r), and/or constant or non-constant distance d between the various beam splitter/combiner assemblies (135t/r).

Accordingly, in view of the above embodiments, methods and devices have been disclosed that enable a planar bidirectional optical coupler for optical data communication with wavelength division multiplexing and/or OTDR measurement capabilities that can be fit within a compact optical transceiver module.

While the invention has generally been described as a planar bidirectional optical coupler in an optical transceiver, the invention is not so limited. The optical transceiver may be an optical transmitter, which has only transmit capabilities. Alternatively, the optical transceiver may be an optical receiver, which has only receive capabilities. For either the optical transmitter or the optical receiver a single optical fiber may carry optical signals from/to the optical transmitter/receiver. The single optical fiber may carry wavelength division multiplex optical signals as previously described. Thus, a planar bidirectional optical coupler may in some instances only be configured to propagate optical signals in a single direction. In such cases the planar bidirectional optical couple may be said to be a planar unidirectional optical coupler. A planar unidirectional optical coupler may be part of a transmitter and require only a light emitter assembly and beam combiner or it may be part of a receiver and require only a light detector assembly and a beam splitter. A WDM optical interconnect module may refer to either an optical transceiver, an optical receiver, or an optical transmitter.

Embodiments with OTDR functionality incorporated into the WDM optical interconnect module having a single optical fiber coupled to the optical interconnect module may have bidirectional communication capability. The light detector shown in FIG. 2 (110d) may serve to receive optical signals propagating into the WDM optical interconnect module. Thus, it may be said that the light detector (110d) may have a dual functionality of both being part of an OTDR system and being a receiver in an asymmetric bidirectional communication system. The bandwidth of the communication system may be asymmetric with wavelength division multiplexed optical signals produced on the transmit side of the WDM optical interconnect module having a higher bandwidth than the optical signals received by the light detector (110d).

The invention has generally been described as using a VCSEL light source in the carrier layer (110), but the invention is not so limited. Edge emitting laser diodes may be used as the light source in the carrier layer (110) instead of VCSELs. Alternatively, the light source may be a photonic integrated circuit (PIC) that utilizes a mirror or surface grating coupler to couple light between the PIC and the lens layer (120) (see FIG. 2). Surface grating couplers generally emit and/or receive light at an oblique angle of incidence to a coupling aperture of the surface grating coupler. As such, the orientation of the plurality of lateral surfaces (1351, 1352, . . . , 1355) may be different than 45 degrees when the optical interconnect module uses a PIC with a surface grating coupler.

A signal mode light source, such as a PIC or single mode VCSEL, may be coupled into either a single mode or a multimode optical fiber by the WDM optical interconnect module. Use of a multimode optical fiber will result in more relaxed mechanical tolerances improving manufacturability.

In other embodiments of the invention, a through electrically conductive via may connect the bottom surface of the transparent carrier substrate with the top surface of the transparent carrier substrate. Use an electrically conductive via allows electrical components to be mounted on the top surface as well as the bottom surface of the transparent carrier substrate.

It will be understood that many additional changes in the details, materials, steps and arrangement of parts, which have been herein described and illustrated to explain the nature of the invention, may be made by those skilled in the art within the principle and scope of the invention as expressed in the appended claims. For example, the invention may be used with a long wavelength WDM system, such as wavelengths between 1200 nm and 1600 nm. The invention has generally been described as using multimode optical fiber, but in some embodiments single mode optical fiber may be used.

It is understood that the specific order or hierarchy of steps in the processes disclosed is an example of applicable approaches. Based upon design preferences, the specific order or hierarchy of steps in the processes may be rearranged while remaining within the scope of the present disclosure. The accompanying method claims present elements of the various steps in a sample order and are not meant to be limited to the specific order or hierarchy presented.

1. A wavelength division multiplexing (WDM) optical interconnect module for optical data communication based on a plurality of wavelengths, comprising:
a planar bidirectional optical coupler, comprising:
a transparent carrier substrate comprising a metallized surface;
a transparent lens substrate comprising a plurality of lenses, the plurality of lens including both a plurality of collimating lenses and a plurality of focusing lenses, the transparent lens substrate overlying the transparent carrier substrate; and
a beam splitter/combiner assembly comprising a plurality of coated lateral surfaces, the beam splitter/combiner assembly overlying the transparent lens substrate,
wherein each coated lateral surface of the plurality of coated lateral surfaces is optically aligned with a respective lens of the plurality of lenses, the each coated lateral surface configured to optically couple light of a respective wavelength of the plurality of wavelengths between the each coated lateral surface and the respective lens.

2. The WDM optical interconnect module of claim 1, wherein:
the transparent carrier substrate and the transparent lens substrate are planar according to a plane that is orthogonal to a direction z, and
the plurality of coated lateral surfaces are parallel to one another and at an angle equal to 45 degrees with respect to the direction z.

3. The WDM optical interconnect module of claim 2, wherein:
an optical axis of each lens of the plurality of lenses is according to the direction z and passes through the respective coated lateral surface of the plurality of coated lateral surfaces and,
a focal plane of each lens of the plurality of lenses is at or near the metallized surface of the transparent carrier substrate.

4. The WDM optical interconnect module of claim 3, wherein:
the transparent carrier substrate comprises, on the metallized surface:
a plurality of light emitters, each light emitter of the plurality of light emitters having an optical axis that is aligned with the optical axis of a respective collimating lens of the plurality of collimating lenses, and
each light emitter of the plurality of light emitters is configured to emit light at the respective wavelength of the respective coated lateral surface.

5. The WDM optical interconnect module of claim 4, wherein:
coupling of light of the plurality of wavelengths to the planar bidirectional optical coupler is provided through an optical axis in a direction y that is orthogonal to the direction z, the optical axis intersecting a first coated lateral surface of the plurality of coated lateral surfaces of the beam splitter/combiner assembly.

6. The WDM optical interconnect module of claim 5, wherein each coated lateral surface of the plurality of coated lateral surfaces is configured to rotate a direction of light of the respective wavelength from the direction y to the direction z and vice versa.

7. The WDM optical interconnect module of claim 6, wherein each coated lateral surface of the plurality of coated lateral surfaces is configured to pass light of a wavelength different from the respective wavelength.

8. The WDM optical interconnect module of claim 6, wherein a last coated lateral surface of the plurality of coated lateral surfaces, furthest from the first coated lateral surface, is not wavelength selective in its reflective properties.

9. (canceled)

10. The WDM optical interconnect module of claim 2, wherein:
coupling of light of the plurality of wavelengths to the planar bidirectional optical coupler is provided through an optical axis in the direction z, the optical axis intersecting a first coated lateral surface of the plurality of coated lateral surfaces of the beam splitter/combiner assembly.

11.-26. (canceled)

27. A wavelength division multiplexing (WDM) optical interconnect module for optical data communication based on a plurality of wavelengths, comprising:
a planar bidirectional optical coupler, comprising:
a transparent carrier substrate comprising a metallized surface, the metallized surface having a plurality of electro-optical elements mounted to the metallized surface;
a transparent lens substrate comprising a plurality of lenses, the plurality of lens including both a plurality of collimating lenses and a plurality of focusing lenses, the transparent lens substrate overlying the transparent carrier substrate; and
a beam splitter/combiner layer overlying the transparent lens substrate, the beam splitter/combiner layer comprising a beam splitter/combiner assembly comprising a plurality of coated lateral surfaces,
wherein each coated lateral surface of the plurality of coated lateral surfaces is optically aligned with a respective lens of the plurality of lenses, the each coated lateral surface configured to optically couple light of a respective wavelength of the plurality of wavelengths between each coated lateral surface and the respective lens.

28. The WDM optical interconnect module of claim 27, wherein:
the transparent carrier substrate and the transparent lens substrate are planar according to a plane that is orthogonal to a direction z, and
the plurality of coated lateral surfaces are parallel to one another and at an angle equal to 45 degrees with respect to the direction z.

29. The WDM optical interconnect module of claim 28, wherein:
an optical axis of each collimating lens of the plurality of lenses is according to the direction z and passes through the respective coated lateral surface of the plurality of coated lateral surfaces, and
a focal plane of each collimating lens of the plurality of collimating lenses is at or near the metallized surface of the transparent carrier substrate.

30. The WDM optical interconnect module of claim 27, wherein:
each electro-optical element of the plurality of electro-optical elements comprises an optical axis that is aligned with the optical axis of a respective lens of the plurality of lenses, and
each electro-optical element of the plurality of electro-optical elements is configured to emit or detect light at the respective wavelength of the respective coated lateral surface.

31. The WDM optical interconnect module of claim 30, wherein:
coupling of light of the plurality of wavelengths from an optical fiber coupled to the WDM optical interconnect module to the planar bidirectional optical coupler is provided through an optical axis in the direction z, the optical axis intersecting a first coated lateral surface of the plurality of coated lateral surfaces of the beam splitter/combiner assembly.

32.-49. (canceled)

50. A wavelength division multiplexing optical interconnect module comprising:
a planar bidirectional optical coupler, comprising:
a transparent carrier substrate comprising a bottom surface having a light emitter assembly mounted on it and an opposed top surface, the light emitter assembly configured to emit light from a plurality of emitting apertures, each emitting aperture configured to emit light at a different wavelength;
a transparent lens substrate comprising a plurality of collimating lenses and a focusing lens, the transparent lens substrate overlying the transparent carrier substrate; and
a beam splitter/combiner layer overlying the transparent lens substrate, the beam splitter/combiner layer comprising a first beam splitter/combiner assembly comprising a first coated lateral surface and a plurality of coated lateral surfaces;
and
a light detector mounted on the bottom surface of the transparent carrier substrate, wherein the first coated lateral surface of the plurality of coated lateral surfaces is optically aligned with the focusing lens and the light detector and each of the plurality of coated lateral surfaces are optically aligned with a collimating lens of the plurality of collimating lenses and an emitting aperture of the plurality of emitting aperture and each of the plurality of coated lateral surfaces reflects light at a wavelength emitted by the light emitter assembly.

51. The wavelength division multiplexing optical interconnect module of claim 50, further comprising:
an optical time domain reflectometer.

52. The wavelength division multiplexing optical interconnect module of claim 51, wherein at least one of the emitting apertures of the light emitter assembly is configured to emit a light pulse and the light detector is configured to detect a reflection of the light pulse, a time delay between the emitted and detected light pulse being used as a signal in the optical time domain reflectometer.

53. The wavelength division multiplexing optical interconnect module of claim 51, wherein the light detector has a dual functionality of both being part of the optical time domain reflectometer and being a receiver in an asymmetric bidirectional communication system.

54.-61. (canceled)

62. The wavelength division multiplexing optical interconnect module of claim 50, further comprising:
a second beam splitter/combiner assembly in the beam splitter/combiner layer that comprises a plurality of coated lateral surfaces; and
a light detector assembly mounted to the bottom surface of the transparent carrier substrate having a plurality of detecting apertures,
wherein the transparent lens substrate further comprises a plurality of receiver focusing lens and each coated lateral surface of the plurality of coated lateral surfaces of the second beam splitter/combiner assembly and each receive focusing lens of the plurality of receive focusing lenses are optically aligned with a respective detecting aperture of the light emitter assembly and each coated lateral surface of the second beam splitter/combiner reflects light at a wavelength detected by a detecting aperture.

63. The wavelength division multiplexing optical interconnect module of claim 62, further comprising a receive optical fiber connector configured to accept a receive optical fiber, wherein each of the detector apertures of the plurality of detecting apertures is optically aligned with the receive optical fiber connector.

64.-71. (canceled)
